(19) United States
(12) Patent Application Publication
(10) Pub. No.: US 2026/0008474 A1
(43) Pub. Date: Jan. 8, 2026

(54) SYSTEMS AND METHODS FOR REDUCING MOBILE DEVICE USAGE BY A DRIVER OF A VEHICLE

(71) Applicant: Quanata, LLC., San Francisco, CA (US)

(72) Inventors: Mark Andrew James Byrne, San Francisco, CA (US); Katrina Andrew James Byrne, San Francisco, CA (US); Michael Joseph Koslap, Yardley, PA (US); Hana Burney, Weehawken, NJ (US); Divya Jain, San Francisco, CA (US)

(73) Assignee: Quanata, LLC, San Francisco, CA (US)

(21) Appl. No.: 19/006,839

(22) Filed: Dec. 31, 2024

Related U.S. Application Data
(63) Continuation-in-part of application No. 18/765,092, filed on Jul. 5, 2024.

(51) Int. Cl. G09B 5/02; G07C 5/02

(52) U.S. Cl. CPC B60W 40/08; G07C 5/02

(57) ABSTRACT

A method can include: receiving telematics data associated with a trip by a vehicle operated by a user; determining, based on the telematics data, that the user has achieved a driving streak of two or more trips without use of a mobile electronic device of the user for any purpose other than pre-approved purposes during the two or more trips; awarding one or more streak tokens to the user based on the user completing a predetermined action; detecting a break in the driving streak of the user; redeeming at least one streak token of the one or more streak tokens of the user; and mending, using the at least one streak token, the driving streak of the user. Other embodiments are disclosed.

### CROSS-REFERENCE TO RELATED APPLICATIONS

This application is a continuation-in-part of U.S. Non-Provisional application Ser. No. 18/765,092 filed on Jul. 5, 2024, which is incorporated by reference herein in its entirety for all purposes.

### FIELD OF THE DISCLOSURE

The present disclosure generally relates to reducing use of mobile devices while driving vehicles.

### BACKGROUND

Distracted driving has been a problem since vehicles first hit the road in the late 1800's. More recently, however, the widespread adoption of mobile technology has accelerated the risks associated with distracted driving, and such technology has turned the distracted driving problem into a threat responsible for thousands of deaths and billions of dollars in damage annually. For example, about 31% of people in the United States have been involved in, or know someone involved in, vehicle accidents due to drivers being distracted by mobile electronic devices such as smartphones. This statistic is not a surprise because over 90% of people in the United States have smartphones, which are designed to capture the attention of their users. Additionally, as estimated in 2019, the annual economic impact of distracted driving was approximately $98 billion in the United States. In fact, in 2022 alone, distracted driving caused over 3,300 fatalities in the United States, and smartphones were determined to have at least contributed to distracted driving resulting in over 12% of these fatalities. Therefore, systems and methods are desired for reducing distracted driving, including reducing use of mobile electric devices while driving.

### BRIEF DESCRIPTION OF THE DRAWINGS

The figures described below depict various aspects of the systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which the same or similar features depicted in multiple figures are designated with the same reference numerals.

The drawings show arrangements that are presently discussed, but it is understood that the depicted and/or described embodiments are not limited to the precise arrangements depicted or described. Accordingly:

FIG. 1 illustrates a front elevation view of one or more computer systems that are suitable for implementing at least a portion of an exemplary embodiment of the system disclosed in FIG. 3;

FIG. 2 illustrates a representative block diagram of an example of elements included in circuit boards inside the chassis of the computer system of FIG. 1;

FIG. 3 illustrates a system for reducing mobile electronic device usage by a driver of a vehicle, according to one exemplary embodiment;

FIG. 4 illustrates a flow chart for a method for reducing mobile electronic device usage by a driver of a vehicle, according to one exemplary embodiment;

FIG. 5 illustrates a first portion of an exemplary flow chart and related exemplary displayed content on a graphical user interface of a mobile electronic device, according to one exemplary embodiment;

FIG. 6 illustrates a second portion of the exemplary flow chart and related exemplary displayed content on the graphical user interface of the mobile electronic device, according to the exemplary embodiment of FIG. 5;

FIG. 7 illustrates a third portion of the exemplary flow chart and related exemplary displayed content on the graphical user interface of the mobile electronic device, according to the exemplary embodiment of FIG. 5;

FIG. 8 illustrates a fourth portion of the exemplary flow chart and related exemplary displayed content on the graphical user interface of the mobile electronic device, according to the exemplary embodiment of FIG. 5;

FIG. 9 illustrates a fifth portion of the exemplary flow chart and related exemplary displayed content on the graphical user interface of the mobile electronic device, according to the exemplary embodiment of FIG. 5;

FIG. 10 illustrates a sixth portion of the exemplary flow chart and related exemplary displayed content on the graphical user interface of the mobile electronic device, according to the exemplary embodiment of FIG. 5;

FIG. 11 illustrates a seventh portion of the exemplary flow chart and related exemplary displayed content on the graphical user interface of the mobile electronic device, according to the exemplary embodiment of FIG. 5;

FIG. 12 illustrates a flow chart of a method of earning and using streak tokens, according to an embodiment;

FIGS. 13A-13D illustrate flow charts for system flows, according to an embodiment;

FIGS. 14A-14G illustrates a first portion of a flow chart and related displayed content on a graphical user interface of a mobile electronic device, according to an embodiment;

FIGS. 15A-15G illustrates a second portion of the flow chart and related displayed content on the graphical user interface of the mobile electronic device, according to the embodiment of FIGS. 14A-14G;

FIGS. 16A-16D illustrates a third portion of the flow chart and related displayed content on the graphical user interface of the mobile electronic device, according to the embodiment of FIGS. 14A-14G;

FIG. 17 illustrates a fourth portion of the flow chart and related displayed content on the graphical user interface of the mobile electronic device, according to the embodiment of FIGS. 14A-14G;

FIGS. 18A-18F illustrates a fifth portion of the flow chart and related displayed content on the graphical user interface of the mobile electronic device, according to the embodiment of FIGS. 14A-14G; and

FIG. 19 illustrates examples of streak token application logic, according to an embodiment.

The figures depict embodiments for purposes of illustration only. One skilled in the art will readily recognize from the following discussion that alternative embodiments of the systems and methods illustrated herein can be employed without departing from the principles of the technology described herein.

### DETAILED DESCRIPTION OF THE DRAWINGS

The present embodiments can generally relate to, inter alia, at least one of tracking the use of mobile electronic devices by people while the people are driving vehicles, reducing such use of mobile electronic devices by such people while they are driving vehicles, motivating people to reduce use of mobile electronic devices while driving vehicles, reducing distracted driving by people, and/or motivating people to reduce distracted driving. Current telematics technology has been used to track the movement of vehicles, but such telematics technology is limited and does not determine whether people are distracted while operating their vehicles or whether people are using their mobile electronic devices while operating their vehicles.

More specifically, various embodiments can include a method being implemented via execution of computing instructions configured to run on one or more processors and stored on one or more non-transitory computer-readable media. The method can include receiving telematics data for a vehicle, and analyzing the telematics data to make a first determination that a mobile electronic device of the user is in the vehicle, the vehicle is moving, and the vehicle is being driven by the user. The method can further include, after making the first determination, making a second determination that the mobile electronic device of the user is not used, during a first vehicle trip of the vehicle, for any purpose other than pre-approved purposes while the mobile electronic device of the user is in the vehicle, the vehicle is moving, and the vehicle is being driven by the user during the first vehicle trip. The method can additionally include, after making the second determination, storing a first record in an electronic ledger, wherein the first record indicates the first vehicle trip occurred without use of the mobile electronic device for any purpose other than the pre-approved purposes. The method also can include, after storing the first record, making a third determination that the mobile electronic device of the user is not used, during a second vehicle trip of the vehicle, for any purpose other than the pre-approved purposes while the mobile electronic device of the user is in the vehicle, the vehicle is moving, and the vehicle is being driven by the user during the second vehicle trip. The method can still further include, after making the third determination, storing a second record in the electronic ledger, wherein the second record indicates the second vehicle trip occurred without use of the mobile electronic device for any purpose other than the pre-approved purposes. The method can additionally include, after storing the second record, transmitting a streak-increment notification to the mobile electronic device about a driving streak for the user. The method also can include additional, less, or alternate functionality, including that discussed elsewhere herein.

In other embodiments, a system can be provided. The system can include one or more local or remote processors, servers, sensors, memory units, transceivers, mobile devices, wearables, smart watches, smart rings, smart glasses or contacts, augmented reality glasses, virtual reality headsets, mixed or extended reality headsets, voice bots, chat bots, artificial intelligence bots, and/or other electronic or electrical components, which can be in wired or wireless communication with one another. For instance, in one aspect, a computer system can include one or more local or remote processors and/or associated transceivers, along with one or more local or remote non-transitory computer-readable media storing computing instructions that, when run on the one or more processors, direct the one or more processors to perform one or more operations.

The operations can include receiving telematics data for a vehicle, and analyzing the telematics data to make a first determination that a mobile electronic device of the user is in the vehicle, the vehicle is moving, and the vehicle is being driven by the user. The operations can further include, after making the first determination, making a second determination that the mobile electronic device of the user is not used, during a first vehicle trip of the vehicle, for any purpose other than pre-approved purposes while the mobile electronic device of the user is in the vehicle, the vehicle is moving, and the vehicle is being driven by the user during the first vehicle trip. The operations can additionally include, after making the second determination, storing a first record in an electronic ledger, wherein the first record indicates the first vehicle trip occurred without use of the mobile electronic device for any purpose other than the pre-approved purposes. The operations also can include, after storing the first record, making a third determination that the mobile electronic device of the user is not used, during a second vehicle trip of the vehicle, for any purpose other than the pre-approved purposes while the mobile electronic device of the user is in the vehicle, the vehicle is moving, and the vehicle is being driven by the user during the second vehicle trip. The operations can still further include, after making the third determination, storing a second record in the electronic ledger, wherein the second record indicates the second vehicle trip occurred without use of the mobile electronic device for any purpose other than the pre-approved purposes. The operations can additionally include, after storing the second record, transmitting a streak-increment notification to the mobile electronic device about a driving streak for the user. The system can be configured to include additional, less, or alternate functionality, including that discussed elsewhere herein.

In further embodiments, a non-transitory computer readable storage medium storing computing instructions can be provided. The computing instructions, when run on one or more processors, can cause the one or more processors to perform operations including receiving telematics data for a vehicle, and analyzing the telematics data to make a first determination that a mobile electronic device of the user is in the vehicle, the vehicle is moving, and the vehicle is being driven by the user. The operations can further include, after making the first determination, making a second determination that the mobile electronic device of the user is not used, during a first vehicle trip of the vehicle, for any purpose other than pre-approved purposes while the mobile electronic device of the user is in the vehicle, the vehicle is moving, and the vehicle is being driven by the user during the first vehicle trip. The operations can additionally include, after making the second determination, storing a first record in an electronic ledger, wherein the first record indicates the first vehicle trip occurred without use of the mobile electronic device for any purpose other than the pre-approved purposes. The operations also can include, after storing the first record, making a third determination that the mobile electronic device of the user is not used, during a second vehicle trip of the vehicle, for any purpose other than the pre-approved purposes while the mobile electronic device of the user is in the vehicle, the vehicle is moving, and the vehicle is being driven by the user during the second vehicle trip. The operations can still further include, after making the third determination, storing a second record in the electronic ledger, wherein the second record indicates the second vehicle trip occurred without use of the mobile electronic device for any purpose other than the pre-approved purposes. The operations can additionally include, after storing the second record, transmitting a streak-increment notification to the mobile electronic device about a driving streak for the user. The non-transitory computer readable storage medium can be configured to include additional, less, or alternate functionality, including that discussed elsewhere herein.

In other embodiments, a method can be implemented via execution of computing instructions configured to run on one or more processors and stored on one or more non-transitory computer-readable media. The method can include: receiving telematics data associated with a trip by a vehicle operated by a user; determining, based on the telematics data, that the user has achieved a driving streak of two or more trips without use of a mobile electronic device of the user for any purpose other than pre-approved purposes during the two or more trips; awarding one or more streak tokens to the user based on the user completing a predetermined action; detecting a break in the driving streak of the user; redeeming at least one streak token of the one or more streak tokens of the user; and mending, using the at least one streak token, the driving streak. The method can be configured to include additional, less, or alternate functionality, including that discussed elsewhere herein.

In further embodiments, a system can include one or more processors; and one or more non-transitory computer-readable media storing computing instructions that, when run on the one or more processors, cause the one or more processors to perform operations. The operations can include: receiving telematics data associated with a trip by a vehicle operated by a user; determining, based on the telematics data, that the user has achieved a driving streak of two or more trips without use of a mobile electronic device of the user for any purpose other than pre-approved purposes during the two or more trips; awarding one or more streak tokens to the user based on the user completing a predetermined action; detecting a break in the driving streak of the user; redeeming at least one streak token of the one or more streak tokens of the user; and mending, using the at least one streak token, the driving streak. The operations can be configured to include additional, less, or alternate functionality, including that discussed elsewhere herein.

In additional embodiments, a non-transitory computer readable storage medium can store computing instructions. The computing instructions, when run on one or more processors, can cause the one or more processors to perform operations. The operations can include: receiving telematics data associated with a trip by a vehicle operated by a user; determining, based on the telematics data, that the user has achieved a driving streak of two or more trips without use of a mobile electronic device of the user for any purpose other than pre-approved purposes during the two or more trips; awarding one or more streak tokens to the user based on the user completing a predetermined action; detecting a break in the driving streak of the user; redeeming at least one streak token of the one or more streak tokens of the user; and mending, using the at least one streak token, the driving streak. The operations can be configured to include additional, less, or alternate functionality, including that discussed elsewhere herein.

Advantages will become more apparent to those skilled in the art from the following description of the embodiments which have been shown and described by way of illustration. As will be realized, the present embodiments can be capable of other and different embodiments, and their details are capable of modification in various respects. Accordingly, the drawings and description are to be regarded as illustrative in nature and not as restrictive.

In some embodiments, the methods, systems, and non-transitory computer readable storage media can be used to determine a discount in the insurance premium for an auto or health insurance policy. In other embodiments, the methods, systems, and non-transitory computer readable storage media can be used to make an employment decision about hiring employees or contractors to drive vehicles. In further embodiments, the methods, systems, and non-transitory computer readable storage media can be used to evaluate a person's fitness to drive when renewing the person's driver's license. In additional embodiments, the methods, systems, and non-transitory computer readable storage media can be used to validate telematics data sent from a person's mobile electronic device, etc.

In many embodiments, the techniques described herein can provide one or more practical applications and technological improvements. The techniques described herein can provide a technical improvement to telematics data. As a first example, the techniques described herein can be used to implicitly validate telematics data. The techniques described herein can provide improvement over conventional approaches that merely use the telematics data without validating the data. Accordingly, the techniques described herein can be used to combat fraud and other problems when the telematics data is used to determine discounts in insurance premiums, to make employee or contractor hiring decisions, to renew a driver's license, etc. As a second example, the techniques described herein can be used to create and maintain a ledger for the telematics data. The ledger can be used to summarize one or more statistics related to the telematics data. The techniques described herein can provide improvement over conventional approaches that merely store the telematics data without also creating and maintaining a ledger for the data. As a third example, the techniques described herein can be used to save battery power for a mobile electronic device of a driver of a vehicle because the driver is discouraged from using the mobile electronic device while the driver operates the vehicle. This discouragement reduces a likelihood that the display screen of the mobile electronic device turns on and off multiple times during a vehicle trip, which conserves battery power for the mobile electronic device. The techniques described herein can provide improvement over conventional approaches that do not reduce a likelihood that a driver uses or touches a mobile electronic device while driving a vehicle.

### Exemplary Computer Systems

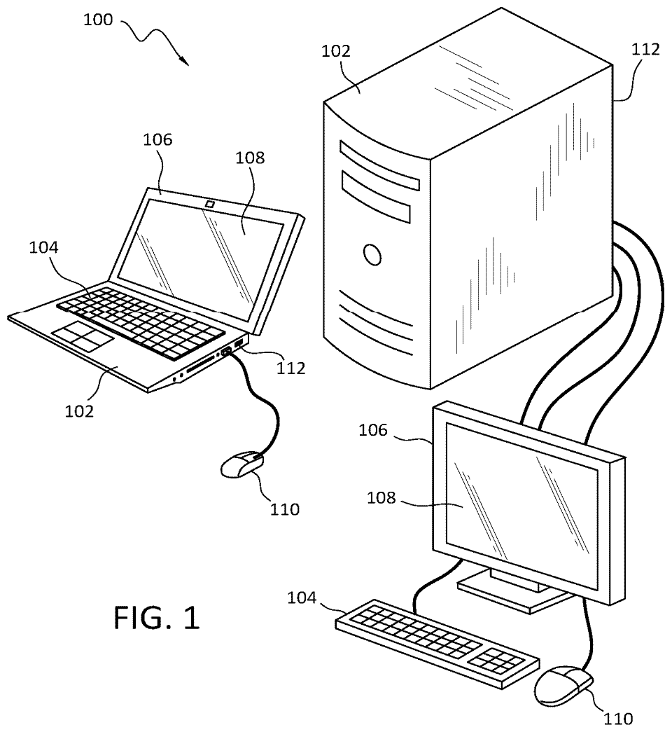

Turning to the drawings, FIG. 1 illustrates an exemplary embodiment of two different types (e.g., a laptop, a tower server, a smartphone, and a smartwatch) of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part, or all of, the techniques described herein. Computer system 100 can comprise chassis 102 containing one or more circuit boards (not shown) and one or more of an input/output port 112 (e.g., one or more universal serial bus (USB) ports of one or more types (e.g., USB type-A, type-B, type-C, micro-A, micro-B, mini-A, mini-B, etc.), one or more High-Definition Multimedia Interface (HDMI) ports, etc.).

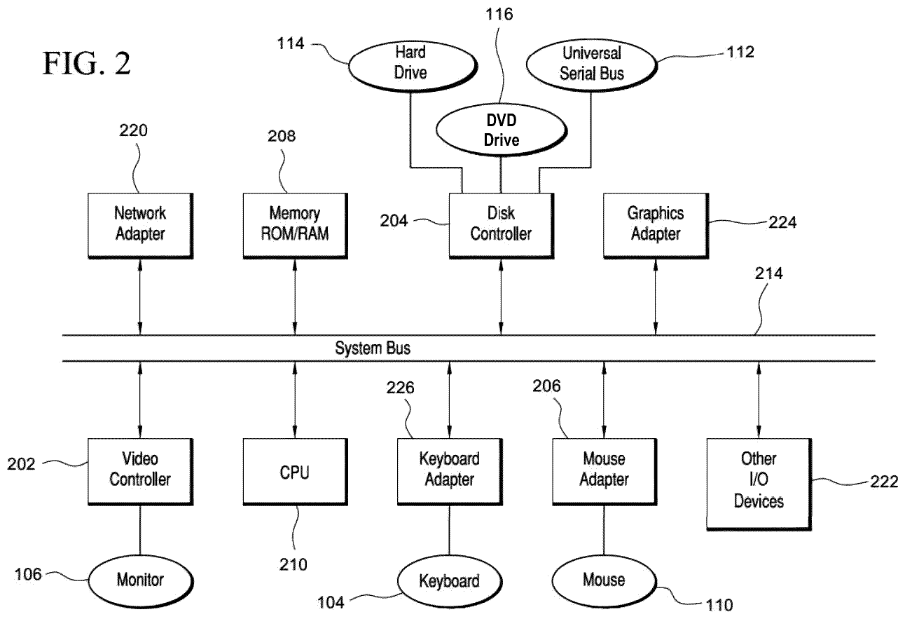

A representative block diagram of the elements included on the circuit boards inside chassis 102 is shown in FIG. 2. A central processing unit (CPU) 210 in FIG. 2 is coupled to a system bus 214. In various embodiments, the architecture of CPU 210 can be compliant with any of a variety of commercially distributed architecture families.

Continuing with FIG. 2, system bus 214 can also be coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to input/output port 112 (FIGS. 1-2)), hard drive 114 (FIG. 2), and/or one or more CD-ROM, DVD, Blu-Ray, or other suitable media, such as media configured to be used in a CD-ROM and/or DVD drive 116 (FIG. 2) inside chassis 102 (FIG. 1) or in a detachable drive coupled to input/output port 112.

Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS by The Open Group Ltd. of Reading, Berkshire in the United Kingdom, and (iv) Linux® OS by Linus Torvalds of Boston, Massachusetts, United State of America.

Further exemplary operating systems can comprise one of the following: (i) the iOS® operating system by Apple Inc. of Cupertino, California, United States of America, (ii) the Blackberry® operating system by Research In Motion (RIM) of Waterloo, Ontario, Mayada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 can be coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIG. 2), input/output port 112 (FIGS. 1-2), and CD-ROM and/or DVD drive 116 (FIG. 2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 by having wireless communication capabilities integrated into the motherboard chipset (not shown), and/or implemented via one or more dedicated wireless communication chips (not shown), connected through a PCI (peripheral component interconnector) or a PCI express bus of computer system 100 (FIG. 1) or input/output port 112 (FIG. 1). In other embodiments, network adapter 220 can comprise and/or be implemented as a wired network interface controller card (not shown).

Although many other components of computer system 100 are not shown, such components and their interconnection are well-known to those of ordinary skill in the art. Accordingly, further details concerning the construction and composition of computer system 100 and the circuit boards inside chassis 102 are not discussed herein.

When computer system 100 in FIG. 1 is running, program instructions stored on a USB drive in input/output port 112, on a CD-ROM or DVD in CD-ROM and/or DVD drive 116 (FIG. 2) or in the detachable CD-ROM and/or DVD drive coupled to input/output port 112, on hard drive 114 (FIG. 2), or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer.

For purposes of illustration, programs and other executable program components are shown herein as discrete systems, although it is understood that such programs and components can reside at various times in different storage components of computer system 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a laptop computer or a tower server in FIG. 1, there can be examples where computer system 100 can take a different form factor while still having functional elements similar to those described for computer system 100. In some embodiments, computer system 100 can comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 can comprise a portable computer, such as a laptop computer. In certain other embodiments, computer system 100 can comprise a mobile device, such as a smartphone, smart glasses, smart watch, smart rings, wearable, virtual reality headset, augmented reality glasses, etc. In certain additional embodiments, computer system 100 can comprise an embedded system.

### Exemplary Computer Systems for Reducing Usage of a Mobile Device by a Driver of a Vehicle

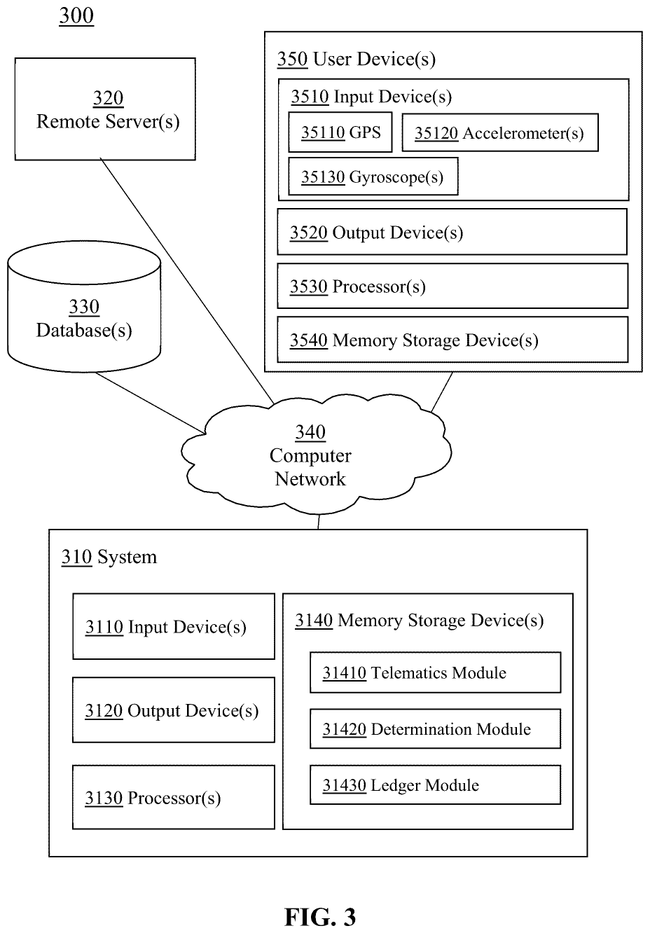

Turning ahead in the drawings, FIG. 3 illustrates a block diagram of a system 300 for tracking the use of mobile electronic devices by a person while driving a vehicle, reducing such use by the person, motivating the person to reduce such use, reducing distracted driving by the person, and/or motivating the person to reduce distracted driving, according to one embodiment. System 300 is exemplary, and embodiments of the system are not limited to the embodiments presented herein. The system can be employed in many different embodiments or examples not specifically depicted or described herein. In some embodiments, certain elements, modules, or systems of system 300 can perform various procedures, processes, operations, actions, and/or activities. In other embodiments, the procedures, processes, operations, actions, and/or activities can be performed by other suitable elements, modules, or systems of system 300.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In some embodiments, system 300 can include one or more systems (e.g., a system 310), one or more remote servers (e.g., a remote server(s) 320), and/or one or more user devices (e.g., a user device(s) 350). System 310, remote server(s) 320, and user device(s) 350 can each be a computer system, such as computer system 100 (FIG. 1), as described above, and can each be a single computer, a single server, or a cluster or collection of computers or servers, or a cloud of computers or servers. In another embodiment, a single computer system can host each of system 310, remote server(s) 320, and user device(s) 350.

In many embodiments, system 310 can be modules of computing instructions (e.g., software modules) stored on non-transitory computer readable media that operate on one or more processors. In other embodiments, system 310 can be implemented in hardware. In many embodiments, system 310 can comprise one or more systems, subsystems, modules, models, or servers (e.g., a telematics module 31410, a determination module 31420, a ledger module 31430, etc.). Each of telematics module 31410, determination module 31420, and ledger module 31430 can be implemented, at least in part, in software and/or firmware stored in or loaded on memory storage device(s) 3140 and executed on processor(s) 3130. Additional details regarding system 310, remote server(s) 320, and user device(s) 350 are described herein.

In some embodiments, system 310 can be in data communication, through a computer network, a telephone network, or the Internet (e.g., computer network 340), with remote server(s) 320, and/or user device(s) 350. In some embodiments, user device(s) 350 can be used by users, such as drivers of vehicles.

In certain embodiments, system 310 and/or remote server(s) 320 can host one or more websites and/or mobile application servers. For example, system 310 and/or remote server(s) 320 can host a website, or provide a server that interfaces with an application (e.g., a mobile application or a web browser), on user device(s) 350, which can allow users to download gaming interfaces and/or interact with (e.g., play, configure, pause, etc.) gaming interfaces (downloaded or executed on system 310 and/or remote server(s) 320) configured to determine the users' gaming performance associated with cognitive factors, in addition to other suitable activities. In some embodiments, an internal network (e.g., computer network 340) that is not open to the public can be used for communications between system 310 and remote server(s) 320 and/or user device(s) 350 within system 300.

In many embodiments, each of user device(s) 350 can include one or more input devices (e.g., input device(s) 3510), one or more output devices (e.g., output device(s) 3520), one or more processors (e.g., processor(s) 3530), and/or one or more memory storage devices (e.g., memory storage device(s) 3540). Examples of input device(s) 3510 can include one or more keyboards, one or more keypads, one or more pointing devices such as a computer mouse or computer mice, one or more touchscreen displays, a microphone, a camera, keyboard 104 (FIG. 1), mouse 110 (FIG. 1), etc. Examples of output device(s) 3520 can include one or more monitors, one or more touch screen displays, projectors, monitor 106 (FIG. 1), screen 108 (FIG. 1), etc. Examples of processor(s) 3530 can include CPU 210 (FIG. 2), etc. Examples of memory storage device(s) 3540 can include memory storage unit 208 (FIG. 2), external storage units coupled to input/output port 112 (FIGS. 1-2), hard drive 114 (FIG. 2), CD-ROM and/or DVD drive 116 (FIG. 2), a detachable drive coupled to input/output port 112 (FIGS. 1-2), etc. In a number of embodiments, input device(s) 3510 further can include one or more cameras and/or one or more microphones. In the same or different embodiments, input device(s) 3510 can include one or more GPS (Global Positioning System) sensor(s) (e.g., GPS sensor(s) 35110), one or more accelerometers (e.g., accelerometer(s) 35120), and/or one or more gyroscopes (e.g., gyroscope(s) 35130).

Input device(s) 3510 and output device(s) 3520 can be coupled to their respective user device(s) 350 in a wired manner and/or a wireless manner, and the coupling can be direct and/or indirect, as well as locally and/or remotely. As an example of an indirect manner (which can or cannot also be a remote manner), a keyboard-video-mouse (KVM) switch can be used to couple input device(s) 3510 and output device(s) 3520 to processor(s) 3530 and/or memory storage device(s) 3540. In some embodiments, the KVM switch also can be part of user device(s) 350. In a similar manner, processor(s) 3530 and/or memory storage device(s) 3540 can be local and/or remote to each other.

In certain embodiments, the user devices (e.g., user device(s) 350) can be a mobile device, and/or other endpoint devices used by one or more users. A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device (e.g., smart glasses, smart watches, smart rings, an augmented-reality (AR) headset, a virtual-reality (VR) headset, etc.), or another portable computer device with the capability to present audio and/or visual data (e.g., images, videos, music, etc.).

Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Exemplary mobile devices can include (i) an iPod®, iPhone®, iTouch®, iPad®, MacBook® or similar product by Apple Inc. of Cupertino, California, United States of America, (ii) a Blackberry® or similar product by Research in Motion (RIM) of Waterloo, Ontario, Mayada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, (ii) the Blackberry® operating system by Research In Motion (RIM) of Waterloo, Ontario, Mayada, (iii) the Android™ operating system developed by the Open Handset Alliance, or (iv) the Windows Mobile™ operating system by Microsoft Corp. of Redmond, Washington, United States of America.

In many embodiments, system 310 can include: (a) one or more input devices (e.g., input device(s) 3110 such as one or more keyboards, one or more keypads, one or more pointing devices such as a computer mouse or computer mice, one or more touchscreen displays, a microphone, a camera, etc.), (b) one or more display or output devices (e.g., output device(s) 3120 such as one or more monitors, one or more touch screen displays, projectors, etc.), (c) one or more processors (e.g., processor(s) 3130), and/or (d) one or more memory storage devices (e.g., memory storage device(s) 3140 such as one or more internal or external memory storage units, one or more hard drives, one or more CD-ROM or DVD drives, etc.). In these or other embodiments, one or more of the input device(s) (e.g., input device(s) 3110) can be similar or identical to keyboard 104 (FIG. 1) and/or a mouse 110 (FIG. 1). Further, one or more of the display device(s) (e.g., output device(s) 3120) can be similar or identical to monitor 106 (FIG. 1) and/or screen 108 (FIG. 1). Additionally, one or more of the processors (e.g., processor(s) 3130) can be similar or identical to CPU 210 (FIG. 2). In similar or different embodiments, one or more of the memory storage devices (e.g., memory storage device(s) 3140) can be similar or identical to memory storage unit 208 (FIG. 2), external storage units coupled to input/output 112 port (FIGS. 1-2), hard drive 114 (FIG. 2), CD-ROM and/or DVD drive 116 (FIG. 2), or a detachable drive coupled to input/output port 112 (FIGS. 1-2).

The input device(s) (e.g., input device(s) 3110) and the display device(s) (e.g., output device(s) 3120) can be coupled to system 310 in a wired manner and/or a wireless manner, and the coupling can be direct and/or indirect, as well as locally and/or remotely. As an example of an indirect manner (which can or cannot also be a remote manner), a keyboard-video-mouse (KVM) switch can be used to couple the input device(s) (e.g., input device(s) 3110) and the display device(s) (e.g., output device(s) 3120) to the processor(s) (e.g., processor(s) 3130) and/or the memory storage unit(s) (e.g., memory storage device(s) 3140). In some embodiments, the KVM switch also can be part of system 310. In a similar manner, the processors and/or the non-transitory computer-readable media can be local and/or remote to each other.

Meanwhile, in many embodiments, system 310 also can be configured to communicate with one or more databases (e.g., a database(s) 330). The one or more databases can include a member database that contains information about the demographic and/or geographic information of members of a population (e.g., insurance policyholders for an insurance company, etc.). The demographic and/or geographic information of the members can include the ages, genders, residences, insurance policies, premiums, payment history, and/or claim histories for the members, for example, among other information. The same or different databases can include telematics data for such members, and/or electronic ledgers related to the telematics data. The one or more databases additionally can include one or more of trained machine learning (ML) and/or artificial intelligence (AI) models (the ML/AI models) used in system 300 and/or system 310. The one or more databases also can include game databases that contain information about the gaming interfaces (e.g., the executable programs of game applications or webpages, etc.). The one or more databases further can include training datasets for various ML/AI models, modules, or systems, including telematics module 31410, determination module 31420, and/or ledger module 31430, etc. The training datasets can be obtained from a third party, generated manually, and/or curated from historical input/output data of one or more pre-trained ML/AI models, etc.

The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, system 300, system 310, and/or the one or more databases (e.g., database(s) 330) can be implemented using any suitable manner of wired and/or wireless communication. Accordingly, system 300 and/or system 310 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc.

The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In many embodiments, system 310 can be configured to transmit to a user device (e.g., user device(s) 350) of a user, a graphical user interface (e.g., a webpage, a graphical user interface of a mobile application, etc.) for display on the user device. The graphical user interface can include statistics (e.g., a current streak count, a longest streak count, a percentage of the month that the user had distraction-free driving, etc.), streak-increment notifications, streak-loss notifications, feedback regarding the current streak count, motivational messages, rewards, and other information related to the electronic ledger and/or driving streaks for the user. System 310 can determine, by using any suitable approaches or ML/AI models, the statistics, motivational messages, and other information. Exemplary algorithms for the ML/AI models for determining the information can include decision trees, K Nearest Neighbor (KNN), neural networks, CatBoost, support vector machine, etc.

### Exemplary Methods and Computer Instructions for Reducing Usage of a Mobile Device by a Driver of a Vehicle

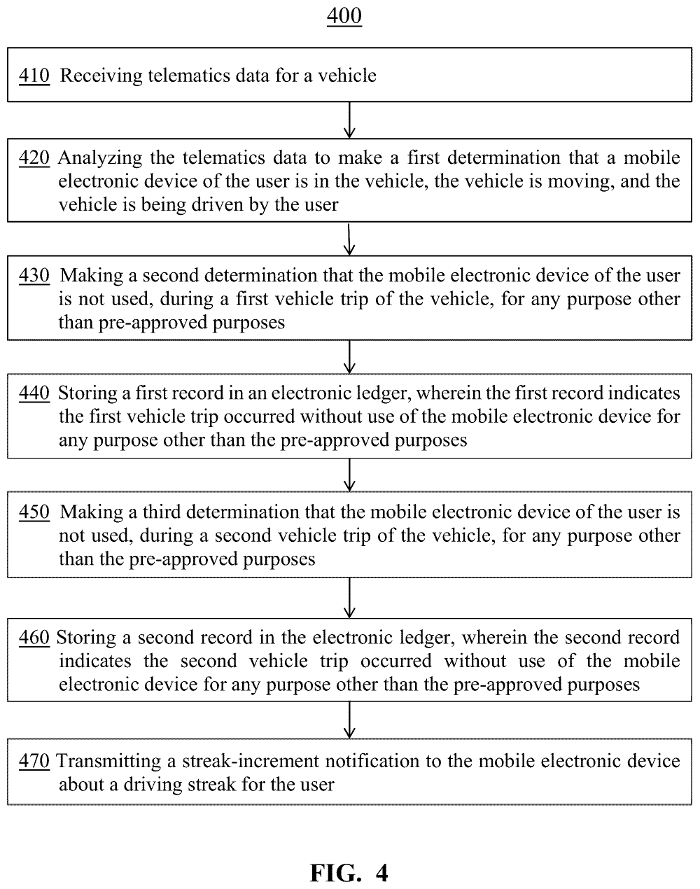

Turning ahead in the drawings, FIG. 4 illustrates actions of a method 400 for tracking the use of mobile electronic devices by a person while driving a vehicle, reducing such use by the person, motivating the person to reduce such use, reducing distracted driving by the person, and/or motivating the person to reduce distracted driving, according to certain embodiments. Method 400 can be implemented via execution of computing instructions configured to run on one or more processors and stored on one or more non-transitory computer-readable media. Method 400 is exemplary and is not limited to the embodiments presented herein. Method 400 can be employed in many different embodiments or examples not specifically depicted or described herein.

In some embodiments, the procedures, the processes, the operations, the actions, and/or the activities of method 400 can be performed in the order presented. In other embodiments, the procedures, the processes, the operations, the actions, and/or the activities of method 400 can be performed in any suitable order. In still other embodiments, one or more of the procedures, the processes, the operations, the actions, and/or the activities of method 400 can be combined or skipped.

In many embodiments, system 300 or system 310 (FIG. 3) (including one or more of its elements, modules, and/or systems, such as telematics module 31410, determination module 31420, ledger module 31430, etc.) can be suitable to perform method 400 and/or one or more of the operations, actions, and/or activities of method 400. In these or other embodiments, one or more of the operations, actions, and/or activities of method 400 can be implemented as one or more computing instructions configured to run on one or more processors and configured to be stored on one or more non-transitory computer readable media. Such non-transitory computer readable media can be part of a computer system such as system 300, system 310, remote server(s) 320, and/or user device(s) 350. The processor(s) can be similar or identical to the processor(s) described above with respect to computer system 100 (FIG. 1).

Referring to FIG. 4, in many embodiments, method 400 can include a block 410 of receiving telematics data for a vehicle. In some embodiments, the telematics data can be transmitted by a mobile electronic device (e.g., one of user device(s) 350 (FIG. 3)) of a user who is driving a vehicle. In these embodiments, the user can authorize an app on the mobile electronic device to use sensors (e.g., GPS sensors) on the mobile electronic device to collect the telematics data during a vehicle trip. The user can authorize the app to use the sensors to collect the telematics data before the vehicle trip begins or at the beginning of the vehicle trip. In other embodiments, the app automatically uses the sensors to collect the telematics data during the vehicle trip, and does not require the user to authorize the app to do so. In still other embodiments, the telematics data can be transmitted by the vehicle being driven by the user. Regardless of the source of the telematics data, the telematics data can be received directly from the source or indirectly from the source through the Internet and/or a cellular network. The telematics data can include GPS data such as speed, acceleration, deceleration, elevation, incline, decline, etc.

In many embodiments, after block 410, method 400 further can include a block 420 of analyzing the telematics data to make a first determination that the mobile electronic device of the user is in the vehicle, the vehicle is moving, and the vehicle is being driven by the user. In various embodiments, determining that the vehicle is being driven by the user of the mobile electronic device can include analyzing sensor data from sensors inside of the vehicle and/or using telematics data from other mobile electronic devices in the vehicle to determine that the user is the driver of the vehicle. In the same or different embodiments, determining that the vehicle is moving can include determining that the vehicle is moving faster than 15 miles per hour. In other embodiments, determining that the vehicle is moving can include determining that the vehicle is moving faster than 5 miles per hour, 10 miles per hour, 20 miles per hour, etc. In various embodiments, the vehicle can be an automobile, a truck, or a van. In other embodiments, the vehicle can be a motorcycle, a bicycle, a boat, or a ship.

In a number of embodiments, after block 420, method 400 also can include a block 430 of making a second determination that the mobile electronic device of the user is not used during a first vehicle trip of the vehicle. In other embodiments, block 430 can include making a second determination that the mobile electronic device of the user is not used, during a first vehicle trip of the vehicle, for any purpose other than pre-approved purposes. In still other embodiments, block 430 also can include making a second determination that the mobile electronic device of the user is not used, during a first vehicle trip of the vehicle, for any purpose other than pre-approved purposes while the mobile electronic device of the user is in the vehicle, the vehicle is moving, and the vehicle is being driven by the user during the first vehicle trip. In many embodiments, the phrase “the mobile electronic device . . . is not used . . . for any purpose other than the pre-approved “purposes” does not require use of the mobile electronic device for any or all of the pre-approved purposes. Instead, the phrase can include situations where the mobile electronic device is not used at all, or where the mobile electronic device is used only to provide the telematics data in block 410 of method 400, or in other situations explained below.

In the same or different embodiments, making the second determination of block 430 can include at least periodically (or continually) monitoring the mobile electronic device during the first vehicle trip to determine whether the mobile electronic device is used, during the first vehicle trip, for any purpose other than the pre-approved purposes while the mobile electronic device of the user is in the vehicle, the vehicle is moving, and the vehicle is being driven by the user during the first vehicle trip.

In the same or different embodiments, the pre-approved purposes can include using the mobile electronic device for navigation and using the mobile electronic device for playing music (where the playing of music can be adjusted by the user operating the mobile electronic device or by the user operating a console of the vehicle, which is coupled to the mobile electronic device via a wireless or wired connection. In other words, if a navigation app on the mobile electronic device is used during the first vehicle trip and/or if a music app on the mobile electronic device is used during the first vehicle trip, such use of the mobile electronic device still permits the second determination to be made. However, in this example, if a texting app (or another non-pre-approved app) on the mobile electronic device is used during the first vehicle trip, then the second determination cannot be made. In further embodiments, the pre-approved purposes can include using the mobile electronic device for any purpose while the vehicle is stopped at a traffic light.

In various embodiments, making the second determination in block 430 can further include analyzing sensor data from at least one of an accelerometer or a gyroscope of the mobile electronic device to determine, at least in part, that the mobile electronic device of the user is not used, during a first vehicle trip, for any purpose other than pre-approved purposes. In other embodiments, making the second determination in block 430 can include analyzing sensor data from at least one of an accelerometer or a gyroscope of the mobile electronic device, and not analyzing what apps on the mobile electronic device are active or being used. In other words, in these other embodiments, if accelerometer and/or gyroscope data from the mobile electronic device is zero relative to the motion of the vehicle in which the mobile electronic device is located, then the user is likely not handling or otherwise touching the mobile electronic device, so the second determination can be made regardless of whether any apps on the mobile electronic device are active or being used during the first vehicle trip. Accelerometer and/or gyroscope data from the mobile electronic device can be zero relative to the motion of the vehicle in which the mobile electronic device is located when the mobile electronic device is stationary relative to the vehicle (i.e., the mobile electronic device is not moved separate from or differently from the movement of the vehicle). In some embodiments, the analysis of the sensor data can be performed by a third party that operates, for example, a remote server, such as remote server(s) 320 (FIG. 3), and in these embodiments, making the second determination in block 430 can including adopting the determination made by the third party that analyzed the sensor data. In embodiments where the second determination can be made regardless of whether any apps on the mobile electronic device are active or being used during the first vehicle trip, the phrase “the mobile electronic device . . . is not used . . . for any purpose other than the pre-approved purposes” can be interpreted to mean the mobile electronic device is not handled by the user/driver of the vehicle during the first vehicle trip. When a user is not touching the mobile electronic device during the first vehicle trip, the integrity of the telematics data sent by the mobile electronic device can be increased because it is less likely that the user is interfering with (whether intentionally or unintentionally) or tampering with the mobile electronic device, the sensor(s) of the mobile electronic device, or the sensor data collected by the sensor(s) and transmitted by the mobile electronic device. In other embodiments, the phrase “the mobile electronic device . . . is not used . . . for any purpose other than the pre-approved purposes” can be interpreted to mean zero seconds of phone distraction.

In many embodiments, after block 430, method 400 additionally can include a block 440 of storing a first record in an electronic ledger, wherein the first record indicates the first vehicle trip occurred without use of the mobile electronic device for any purpose other than the pre-approved purposes. The electronic ledger can be stored in a database.

In many embodiments, after block 440, method 400 further can include a block 450 of making a third determination that the mobile electronic device of the user is not used, during a second vehicle trip of the vehicle, for any purpose other than the pre-approved purposes. In various embodiments, block 450 also can include making a third determination that the mobile electronic device of the user is not used, during a second vehicle trip of the vehicle, for any purpose other than the pre-approved purposes while the mobile electronic device of the user is in the vehicle, the vehicle is moving, and the vehicle is being driven by the user during the second vehicle trip. After block 440 is performed and before block 450 is performed, blocks 410 and 420 can be performed again, or blocks similar to blocks 410 and 420 can be performed. In many embodiments, block 450 can be similar to block 430.

In many embodiments, after block 450, method 400 further can include a block 460 of storing a second record in the electronic ledger, wherein the second record indicates the second vehicle trip occurred without use of the mobile electronic device for any purpose other than the pre-approved purposes. In various embodiments, storing the second record in the electronic ledger can increment a counter of undistracted driving during consecutive driving trips. In many embodiments, block 460 can be similar to block 440.

In many embodiments, after block 460, method 400 further can include a block 470 of transmitting a streak-increment notification to the mobile electronic device about a driving streak for the user. In some embodiments, transmitting the streak-increment notification occurs only after the second vehicle trip has ended. In these embodiments, transmission of the streak-increment notification to the mobile electronic device of the user does not distract the user while the user is driving the vehicle during the second vehicle trip. In the same or different embodiments, the streak-increment notification can be transmitted for display on an app on the mobile electronic device, where the app is the same app that was involved with block 410 of method 400. In various embodiments, the streak count does not impact the user's driver score, which can be determined by factors other than the current streak count for the user, the maximum streak count for the user, or any other aspect of the streak count.

In other embodiments, after block 460, method 400 further can include making a fourth determination that the mobile electronic device of the user is used, during a third vehicle trip of the vehicle, for a purpose other than the pre-approved purposes. Making the fourth determination can include making a fourth determination that the mobile electronic device of the user is used, during a third vehicle trip of the vehicle, for a purpose other than the pre-approved purposes. In similar embodiments, making the fourth determination can include making a fourth determination that the mobile electronic device of the user is used, during a third vehicle trip of the vehicle, for a purpose other than the pre-approved purposes while the mobile electronic device of the user is in the vehicle, the vehicle is moving, and the vehicle is being driven by the user during the third vehicle trip.

After making the fourth determination, method 400 further can include transmitting a streak-loss notification to the mobile electronic device about termination of the driving streak for the user. In these embodiments, the transmission of the streak-loss notification can occur only after the third vehicle trip has ended. In these embodiments, transmission of the streak-increment notification to the mobile electronic device of the user does not distract the user while the user is driving the vehicle during the second vehicle trip. In the same or different embodiments, the streak-increment notification can be transmitted for display on an app on the mobile electronic device, where the app is the same app that was involved with block 410 of method 400.

In different embodiments, if the fourth determination is made preliminarily, then method 400 further can include transmitting a notice to the mobile electronic device to warn the user who is simultaneously driving the vehicle during the third vehicle trip and operating the mobile electronic device that the user is in danger of losing the user's streak of no distracted driving unless the user stops using the mobile electronic device within a pre-determined period of time. In these different embodiments, the transmission of the warning notice can occur during the third vehicle trip while the user is using or touching the mobile electronic device during the third vehicle trip to provide a timely warning to the user who is simultaneously driving the vehicle. And, if the user does not stop the use or touching of the mobile electronic device during the third vehicle trip, then the fourth determination can be changed from a preliminary determination to a final determination, in which case any streak is broken or lost.

In other embodiments, after block 460, method 400 further can include transmitting a reward to the mobile electronic device after the user achieves a streak milestone. In some embodiments, transmitting the reward occurs only when a vehicle trip is not in progress. In these embodiments, transmission of the reward to the mobile electronic device of the user does not distract the user while the user is driving the vehicle during the second vehicle trip. In various embodiments, the reward can include a discount for a vehicle insurance premium, a different monetary incentive, a reward internal to an app on the mobile electronic device that is involved with blocks 410 and 460 of method 400, a reward external to that app, etc. The reward can be part of a gamification system to motivate the user to continue the streak of no distracted driving and/or no mobile electronic device usage during vehicle trips while driving a vehicle, where the gamification system relies on the user's loss aversion tendencies or desires. In the same or different embodiments, the streak milestone can include a predetermined number of consecutive vehicle trips where the mobile electronic device of the user is determined to not be used, during the consecutive vehicle trips, for any purpose other than the pre-approved purposes. In similar embodiments, the streak milestone can include a predetermined number of consecutive vehicle trips where the mobile electronic device of the user is determined to not be used, during the consecutive vehicle trips, for any purpose other than the pre-approved purposes while the mobile electronic device of the user is in the vehicle, the vehicle is moving, and the vehicle is being driven by the user during the consecutive vehicle trips.

In other embodiments, after block 460, method 400 further can include tracking a longest streak count representing a longest streak of consecutive vehicle trips for the user during which the mobile electronic device of the user is not used for any purpose other than the pre-approved purposes. In similar embodiments, the tracking can include tracking the longest streak count representing the longest streak of consecutive vehicle trips for the user during which the mobile electronic device of the user is not used for any purpose other than the pre-approved purposes while the mobile electronic device of the user is in the vehicle, the vehicle is moving, and the vehicle is being driven by the user during the second vehicle trip. In these embodiments, after the tracking, method 400 further can include at least one of: transmitting, to the mobile electronic device, a current streak count for the user and the longest streak count for the user, or transmitting, to the mobile electronic device, feedback for the user regarding the current streak count for the user.

In a number of embodiments where one or more ML/AI models are used in block 420, block 430, block 440, block 450, block 460, and/or block 470, method 400 further can include pre-training and/or re-training the trained ML/AI models based upon historical input/output data, as determined in block 410, block 450, or block 460 respectively, feedback received from a system user (e.g., a data scientist, a machine learning engineer, etc.) or collected from various data sources (e.g., policy renewal rates, insurance claim trends, a user of an app increasing a streak trend or breaking a streak, etc.), and/or synthesized training data. In these embodiments, the same or different ML/AI models can be used in one or more of block 420, block 430, block 440, block 450, block 460, and/or block 470 in method 400.

For each of the machine learning models to be retrained, the respective training datasets can be updated manually by a system user (e.g., an ML engineer, a data scientist, etc.) and/or automatically by a system (e.g., system 300 or 310 (FIG. 3)). The system user can select new training data from various data sources (e.g., websites, books, magazines, product catalogs, private third-party databases, etc.). The system can collect new training data based upon various criteria. In certain embodiments, historical input and/or output data of the model to be re-trained can be used for re-training the model. In several embodiments, the historical input and/or output data of the model can be selected based upon system performance and/or user feedback from the system user associated with the historical output data. Examples of the user feedback can include a higher streak count, a trend of higher and higher streak counts, etc.), and so forth. In various embodiments, when more than one training dataset is used for the pre-training and/or re-training, the system (e.g., system 300 and/or system 310) can format or re-format the data of the more than one training dataset (especially when datasets are from different sources) so that the hierarchy, schema, and/or other aspects of the data of the more than one training dataset follow a common hierarchy, structure, schema, etc., and so that the data of the more than one training dataset can be more easily used to pre-train or re-train the one or more machine learning models. The system can pre-determine the common hierarchy, structure, schema, etc.

Relating FIG. 4 to FIG. 3, as an example, telematics module 31410 (FIG. 3) can perform blocks 410 and 420; determination module 31420 (FIG. 3) can perform blocks 430 and 450; and ledger module 31430 (FIG. 3) can perform blocks 440, 460, and 470.

In the same or different embodiments, referring back to FIG. 4, method 400 can be revised in different ways. For example, the first vehicle trip of block 430 can occur in a first vehicle, and the second vehicle trip of block 450 can occur in a second vehicle different from the first vehicle. Similarly, the third vehicle trip referenced above can occur in the first vehicle, the second vehicle, or a third vehicle different from the first and second vehicles.

### Additional Exemplary Embodiments for Reducing Mobile Device Usage by a Driver of a Vehicle

In various embodiments, smartphone users and app users do not have a systematic way to improve their distraction-free driving and to possibly lower their monthly vehicle insurance premium based on their improved distraction-free driving. Presenting targeted and specific goals on the app of the mobile electronic device while the user is not driving a vehicle can enable users) who want to get better at driving) to improve their distraction-free driving, raise their awareness of their driving behaviors, and perhaps ultimately lower their monthly vehicle insurance premium. In turn, these techniques can uncover insights into customer behavior, motivations and habits.

Drivers desire their distraction free driving to be recognized and encouraged, so drivers can be reminded to continue to drive safer and save on their vehicle insurance costs. Accordingly, in various embodiments, whenever a driver completes a vehicle trip labelled as driving with zero seconds of phone distraction (based on tracking of phone motion during the vehicle trip), this vehicle trip can be considered a distraction-free vehicle trip, and the driver can have a current active streak of distraction-free driving with a value of 1. The driver's streak progress can be published in near real-time to enable triggering journeys to the driver's mobile electronic device when the driver is not driving. If this distraction-free vehicle trip is the driver's first such trip, then the system can record the vehicle trip as both the current streak and the longest streak. Trip re-classification does not need to be considered and, in at least some embodiments, will not impact active or prior streaks. When the driver completes a subsequent distraction-free vehicle trip (whether in the same or different vehicle), the current streak remains active for this driver, and the streak value is incremented by 1. If the streak value of the current streak is higher than the previously recorded longest streak, then the streak value of the longest streak is replaced with the streak value of the most recently ended streak. The driver's current and longest streak can be published to an app on the driver's mobile electronic device, as described below. If a driver that previously had an active streak completes a subsequent vehicle trip that is not distraction free, then the driver ends the current active streak. This loss can be published to the mobile electronic device of the driver, as described below, after the end of the current vehicle trip.

In other embodiments, an app on a mobile electronic device (owned by a person) can motivate the person to drive safely by publishing on the app a current monthly variable insurance premium discount for the person and also by publishing on the app 4 driving subscores for the person. The publication of this information on the app provides feedback to the person to motivate the person to improve driving behaviors. However, these techniques are often lagging indicators of the person's driving behaviors, and the delay in seeing the positive results of the person's improved driver behaviors is often disconnected from the immediate or other near-term actions that the person can take to improve driving behaviors. By providing near-real-time feedback and creating a sense of investment, along with seeing on the app an incremental streak number increase each time the person takes a positive action (e.g., does not touch smartphone while driving), the app makes the experience engaging and rewarding for the person, while building an underlying habit for the person of driving without touching the person's smartphone. This technology, including its application and subsequent reinforcement of the behavior change with the graphical user interface and supporting lifecycle communications, is uniquely effective at least in part based on the technology's trigger functions (e.g., providing conditional prompts, visual cues, etc. in the app), action functions (e.g., prompting user to take action(s) or to avoid taking action(s)), reward functions (e.g., rewarding user actions or inactions based on milestones, and outcomes, with intrinsic rewards in the app and/or extrinsic rewards, and otherwise celebrating when achieving successes, along with providing encouragement when a streak is broken or has otherwise ended), and investment functions (e.g., taking more actions or inactions, feeling more invested and valuing the app and related products more).

### Additional Exemplary Embodiments of Flow Charts and Graphical User Interfaces for Reducing Mobile Device Usage by a Driver of a Vehicle

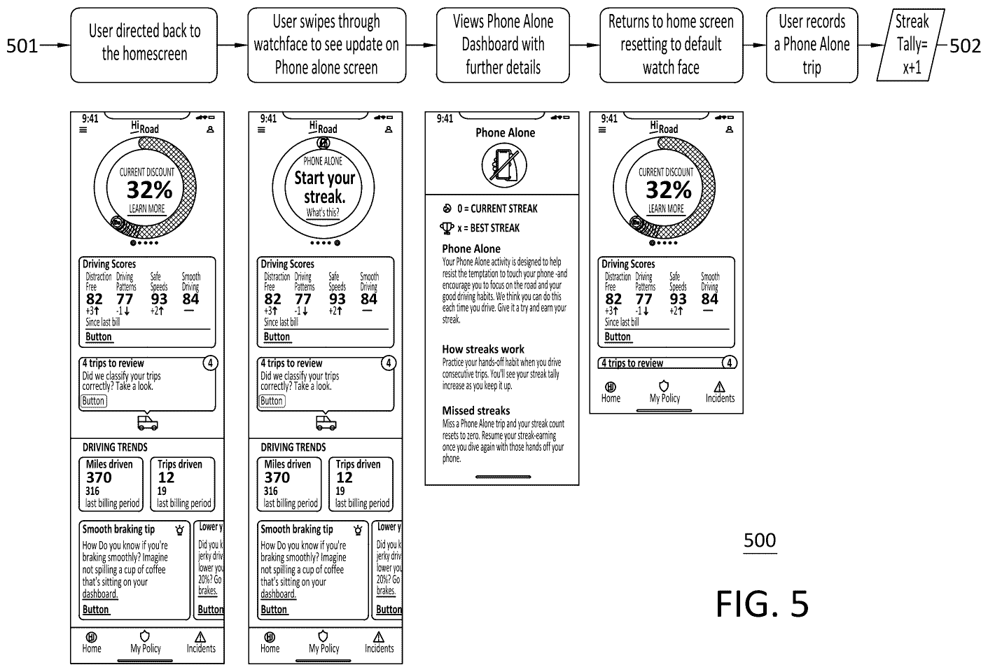

Turning ahead in the drawings, FIGS. 5-11 illustrate different portions of an exemplary flow chart and related exemplary displayed content on a graphical user interface of a mobile electronic device, according to an embodiment. The flow chart and displayed content can be used for, in various embodiments, tracking the use of mobile electronic devices by a person while driving a vehicle, reducing such use by the person, motivating the person to reduce such use, reducing distracted driving by the person, and/or motivating the person to reduce distracted driving.

More specifically FIG. 5 illustrates a first portion of the exemplary flow chart and related exemplary displayed content 500 displayed on a graphical user interface of a mobile electronic device, according to an embodiment. The displayed content is merely exemplary and is not limited to the embodiments presented herein. The displayed content can be employed in many different embodiments or examples not specifically depicted or described herein. In a number of embodiments, the displayed content can include a graphical user interface for an app on the mobile electronic device, similar to the app and mobile electronic device described above with reference to FIGS. 3 and 4. In some embodiments, the graphical user interfaces and/or portions thereof of the displayed content can be arranged in the layout presented in FIG. 5. In other embodiments, the graphical user interfaces and/or portions thereof of the displayed content can be arranged in any suitable layouts. In still other embodiments, one or more of the graphical user interfaces and/or the portions of the displayed content can be combined or omitted. In many embodiments, system 300 (FIG. 3), system 310 (FIG. 3), or method 400 (FIG. 4) can be suitable to generate, transmit, and/or display or cause to display the graphical user interfaces and/or any portions thereof.

As an example, FIG. 5 can show dormant zero streaks. More specifically, starting from reference point 501 in FIG. 5, a user of an app on a mobile electronic device can be directed to (or directed back to) a home screen of the app, and then the user can swipe through a watch face design on the graphical user interface of the app of the mobile electronic device to see an update about a current streak. Next, the user can view a dashboard with further details, and then return to the home screen of the app, resetting to a default watch face design on the graphical user interface of the app on the mobile electronic device. Subsequently, the user can authorize the app to record a vehicle trip, or the app can automatically do so. Upon a successful distraction-free vehicle trip or a vehicle trip without touching the smartphone, a streak tally or electronic ledger can be increased by one, which leads to reference point 502.

As shown in FIG. 5, the graphical user interfaces can display: a current discount of the vehicle insurance premium; driving scores for distraction-free driving, driving patterns, safe speeds, and smooth driving, along with their respective trends; and the start of a streak.

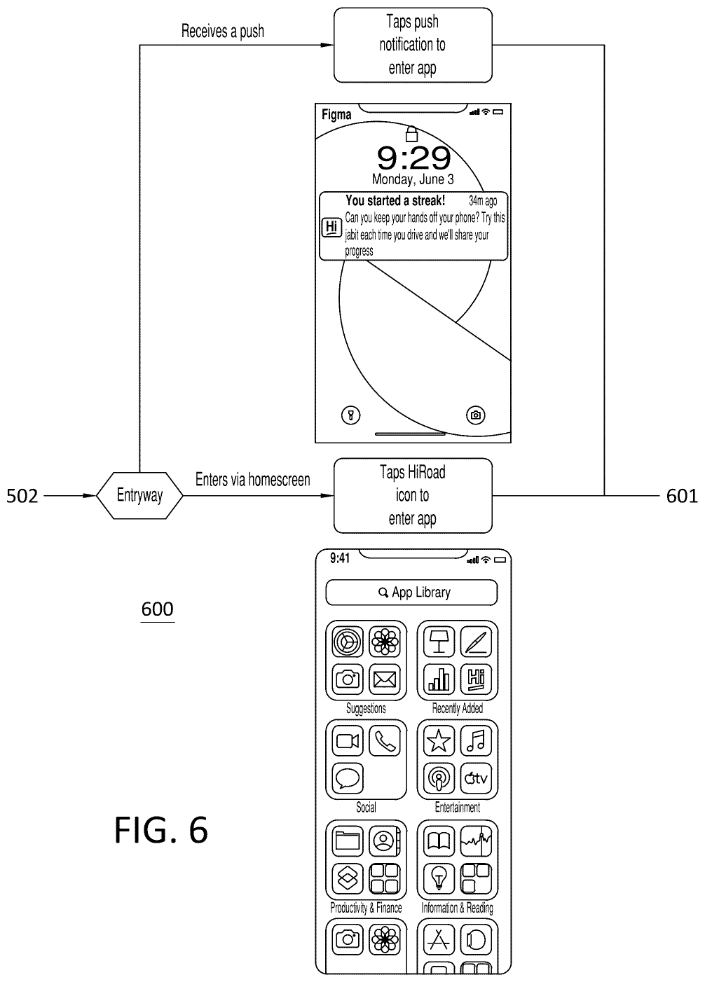

Moving ahead in the drawings, FIG. 6 illustrates a second portion of the exemplary flow chart and related exemplary displayed content 600 on the graphical user interface of the mobile electronic device, according to the exemplary embodiment of FIG. 5. The displayed content is merely exemplary and is not limited to the embodiments presented herein. The displayed content can be employed in many different embodiments or examples not specifically depicted or described herein. In a number of embodiments, the displayed content can include a graphical user interface for an app on the mobile electronic device, similar to the app and mobile electronic device described above with reference to FIGS. 3 and 4. In some embodiments, the graphical user interfaces and/or portions thereof of the displayed content can be arranged in the layout presented in FIG. 5. In other embodiments, the graphical user interfaces and/or portions thereof of the displayed content can be arranged in any suitable layouts. In still other embodiments, one or more of the graphical user interfaces and/or the portions of the displayed content can be combined or omitted. In many embodiments, system 300 (FIG. 3), system 310 (FIG. 3), or method 400 (FIG. 4) can be suitable to generate, transmit, and/or display or cause to display the graphical user interfaces and/or any portions thereof.

As an example, FIG. 6 can show a first portion of an entry into the first streak. More specifically, starting from reference point 502 in FIG. 6, the mobile electronic device can receive a push notification, and the user can tap the push notification to enter or begin the distraction-free (or the no-touching-or-using-the-smartphone) vehicle trip monitoring function of the app on the mobile electronic device, which leads to reference point 601. Separately, starting from reference point 502 in FIG. 6, the user can tap the app icon on a graphical user interface of the mobile electronic device to enter the app, which also leads to reference point 601.

As shown in FIG. 6, the graphical user interfaces can display: a push notification and a home screen on the graphical user interface of the mobile electronic device.

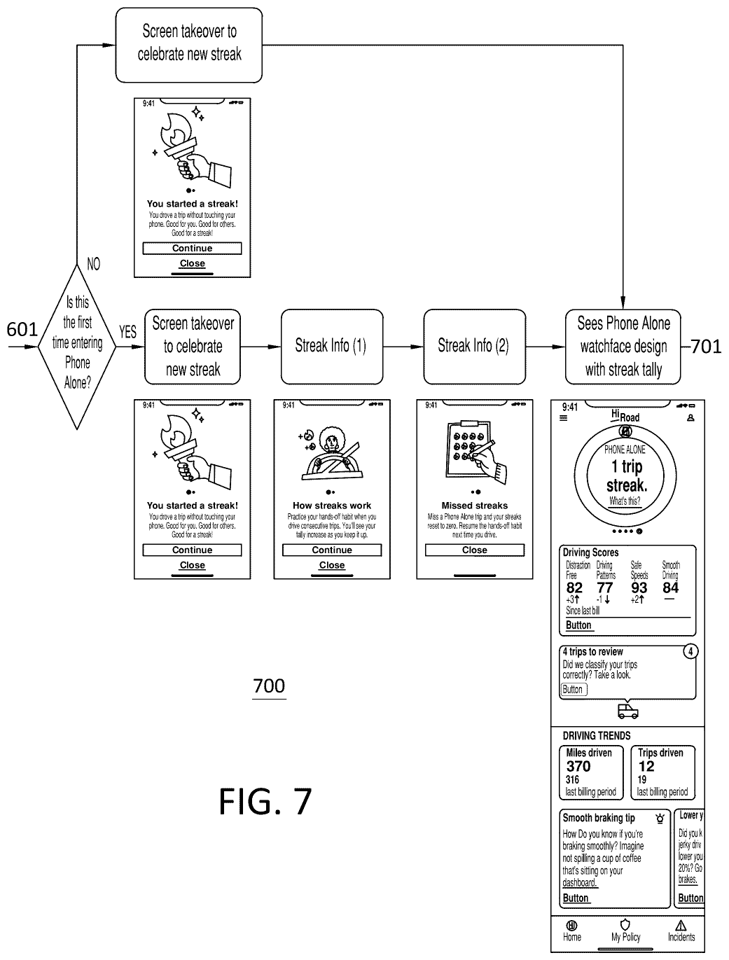

Moving further ahead in the drawings, FIG. 7 illustrates a third portion of the exemplary flow chart and related exemplary displayed content on the graphical user interface of the mobile electronic device, according to the exemplary embodiment of FIG. 5. The displayed content is merely exemplary and is not limited to the embodiments presented herein. The displayed content can be employed in many different embodiments or examples not specifically depicted or described herein. In a number of embodiments, the displayed content can include a graphical user interface for an app on the mobile electronic device, similar to the app and mobile electronic device described above with reference to FIGS. 3 and 4. In some embodiments, the graphical user interfaces and/or portions thereof of the displayed content can be arranged in the layout presented in FIG. 5. In other embodiments, the graphical user interfaces and/or portions thereof of the displayed content can be arranged in any suitable layouts. In still other embodiments, one or more of the graphical user interfaces and/or the portions of the displayed content can be combined or omitted. In many embodiments, system 300 (FIG. 3), system 310 (FIG. 3), or method 400 (FIG. 4) can be suitable to generate, transmit, and/or display or cause to display the graphical user interfaces and/or any portions thereof.

As an example, FIG. 7 can show a second portion of the entry into the first streak. More specifically, starting from reference point 601 in FIG. 7, if this is the first time entering the distraction-free (or the no-touching-or-using-the-smartphone) vehicle trip monitoring function of the app on the mobile electronic device, then the graphical user interface of the app can display a notification to celebrate the beginning of a new streak, and provide additional information regarding streaks. Next, the graphical user interface of the app can display a watch face design with the streak tally or electronic ledger, which leads to reference point 701. On the other hand, if this is not the first time entering the distraction-free (or the no-touching-or-using-the-smartphone) vehicle trip monitoring function of the app on the mobile electronic device, starting from reference point 601 in FIG. 7, then the graphical user interface of the app can display a notification to celebrate the beginning of a new streak, and then the graphical user interface of the app can display a watch face design with the streak tally or electronic ledger, which also leads to reference point 701.

As shown in FIG. 7, the graphical user interfaces can display: a celebration of the beginning of a new streak; information regarding streaks; and a watch face design showing the streak tally or electronic ledger.

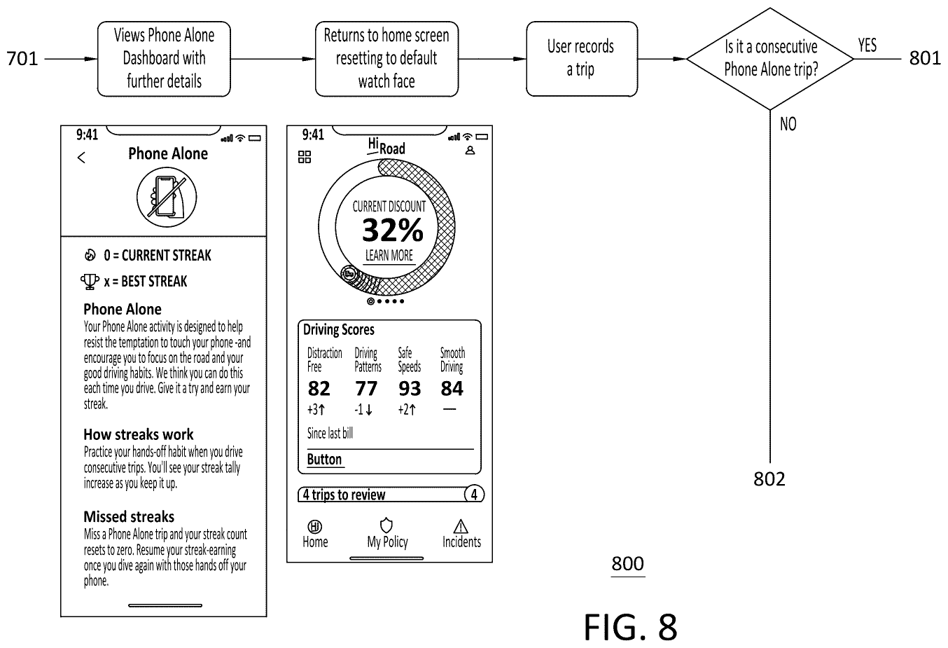

FIG. 8 illustrates a fourth portion of the exemplary flow chart and related exemplary displayed content on the graphical user interface of the mobile electronic device, according to the exemplary embodiment of FIG. 5. The displayed content is merely exemplary and is not limited to the embodiments presented herein. The displayed content can be employed in many different embodiments or examples not specifically depicted or described herein. In a number of embodiments, the displayed content can include a graphical user interface for an app on the mobile electronic device, similar to the app and mobile electronic device described above with reference to FIGS. 3 and 4. In some embodiments, the graphical user interfaces and/or portions thereof of the displayed content can be arranged in the layout presented in FIG. 5. In other embodiments, the graphical user interfaces and/or portions thereof of the displayed content can be arranged in any suitable layouts. In still other embodiments, one or more of the graphical user interfaces and/or the portions of the displayed content can be combined or omitted. In many embodiments, system 300 (FIG. 3), system 310 (FIG. 3), or method 400 (FIG. 4) can be suitable to generate, transmit, and/or display or cause to display the graphical user interfaces and/or any portions thereof.

As an example, FIG. 8 can show a third portion of the entry into the first streak. More specifically, starting from reference point 701 in FIG. 8, after the user clicks on a “What's this?” or equivalent link or button on the previous graphical user interface of FIG. 7 leading to reference point 701, the graphical user interface of the app on the mobile electronic device can display a dashboard with additional information about streaks, and then the graphical user interface can display the home screen of the app, resetting to a default watch face design. Next, the user or app can record a vehicle trip. If the vehicle trip is a successful distraction-free vehicle trip or a successful vehicle trip without touching the smartphone, then the flow chart leads to reference point 801. However, if the vehicle trip is not a successful distraction-free vehicle trip or is not a successful vehicle trip without touching the smartphone, then the flow chart leads to reference point 802. A successful distraction-free vehicle trip or a successful vehicle trip without touching the smartphone also can be referred to as a consecutive distraction-free vehicle trip or a consecutive vehicle trip without touching the smartphone.

As shown in FIG. 8, the graphical user interfaces can display: information regarding streaks; and a default watch face design showing a current discount for a monthly vehicle insurance premium.

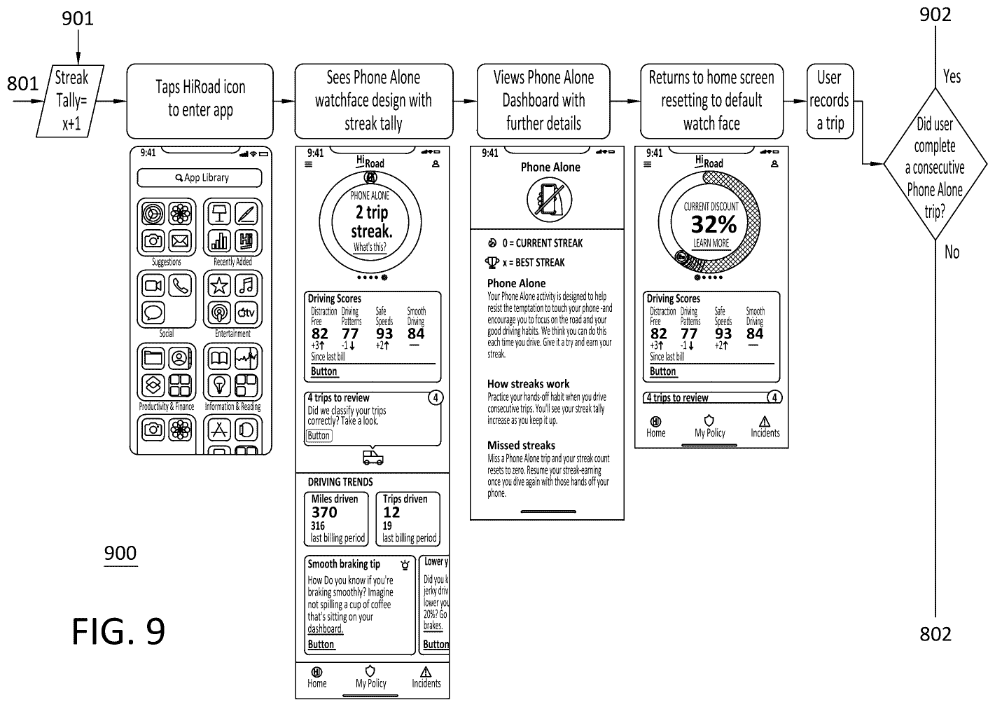

FIG. 9 illustrates a fifth portion of the exemplary flow chart and related exemplary displayed content on the graphical user interface of the mobile electronic device, according to the exemplary embodiment of FIG. 5. The displayed content is merely exemplary and is not limited to the embodiments presented herein. The displayed content can be employed in many different embodiments or examples not specifically depicted or described herein. In a number of embodiments, the displayed content can include a graphical user interface for an app on the mobile electronic device, similar to the app and mobile electronic device described above with reference to FIGS. 3 and 4. In some embodiments, the graphical user interfaces and/or portions thereof of the displayed content can be arranged in the layout presented in FIG. 5. In other embodiments, the graphical user interfaces and/or portions thereof of the displayed content can be arranged in any suitable layouts. In still other embodiments, one or more of the graphical user interfaces and/or the portions of the displayed content can be combined or omitted. In many embodiments, system 300 (FIG. 3), system 310 (FIG. 3), or method 400 (FIG. 4) can be suitable to generate, transmit, and/or display or cause to display the graphical user interfaces and/or any portions thereof.

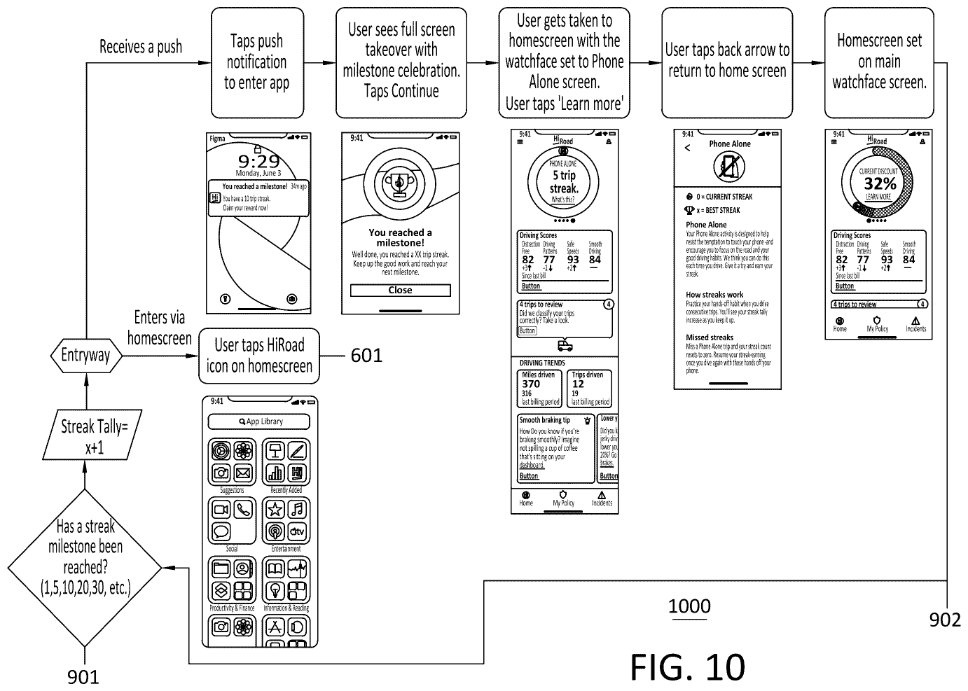

As an example, FIG. 9 can show a loop for consecutive streaks. More specifically, starting from reference point 801 in FIG. 9, the streak tally or electronic ledger can be increased by one, and then the user can tap the app icon on the home screen of the graphical user interface for the mobile electronic device. Next, the graphical user interface of the app on the mobile electronic device can display a watch face design showing the streak tally, and then (after the user clicks on a “What's this?” or equivalent link or button on the previous graphical user interface) the graphical user interface of the app can display further details regarding streaks. Subsequently, after the user clicks on the back arrow, the app can return to its home screen, resetting to the default watch face design showing a current discount on the monthly vehicle insurance premium, and the user or app can record a vehicle trip. If the vehicle trip is a successful distraction-free vehicle trip or a successful vehicle trip without touching the smartphone, then the flow chart leads to reference point 902. However, if the vehicle trip is not a successful distraction-free vehicle trip or is not a successful vehicle trip without touching the smartphone, then the flow chart leads to reference point 802. As noted above, a successful distraction-free vehicle trip or a successful vehicle trip without touching the smartphone also can be referred to as a consecutive distraction-free vehicle trip or a consecutive vehicle trip without touching the smartphone. Reference point 901 in FIG. 9 will be explained later with reference to FIG. 10.

As shown in FIG. 9, the graphical user interfaces can display: a home screen on a graphical user interface of a mobile electronic device, a watch face design showing the streak tally, further details regarding streaks, and a default watch face design showing a current discount on a monthly vehicle insurance premium, along with driving scores for distraction-free driving, driving patterns, safe speeds, and smooth driving, and their respective trends.

FIG. 10 illustrates a sixth portion of the exemplary flow chart and related exemplary displayed content on the graphical user interface of the mobile electronic device, according to the exemplary embodiment of FIG. 5. The displayed content is merely exemplary and is not limited to the embodiments presented herein. The displayed content can be employed in many different embodiments or examples not specifically depicted or described herein. In a number of embodiments, the displayed content can include a graphical user interface for an app on the mobile electronic device, similar to the app and mobile electronic device described above with reference to FIGS. 3 and 4. In some embodiments, the graphical user interfaces and/or portions thereof of the displayed content can be arranged in the layout presented in FIG. 5. In other embodiments, the graphical user interfaces and/or portions thereof of the displayed content can be arranged in any suitable layouts. In still other embodiments, one or more of the graphical user interfaces and/or the portions of the displayed content can be combined or omitted. In many embodiments, system 300 (FIG. 3), system 310 (FIG. 3), or method 400 (FIG. 4) can be suitable to generate, transmit, and/or display or cause to display the graphical user interfaces and/or any portions thereof.

As an example, FIG. 10 can show a loop for milestone streaks. More specifically, starting from reference point 902 in FIG. 10, if a milestone has not been reached, then the flow chart can continue to reference point 901 in FIG. 10 and then the same reference point 901 in FIG. 9, which leads to incrementing the trip tally or electronic ledger by one. As an example, a milestone can be 1 consecutive distraction-free vehicle trip or 1 consecutive vehicle trip without touching the smartphone; 5 consecutive distraction-free vehicle trips or 5 consecutive vehicle trips without touching the smartphone; 10 consecutive distraction-free vehicle trips or 10 consecutive vehicle trips without touching the smartphone; 20 consecutive distraction-free vehicle trips or 20 consecutive vehicle trips without touching the smartphone; 30 consecutive distraction-free vehicle trips or 30 consecutive vehicle trips without touching the smartphone; etc. However, if a milestone has been reached, then the flow chart in FIG. 10 can continue to increment the trip tally or electronic ledger by one, and the graphical user interface of the mobile electronic device can display the home screen, where the user can tap the app icon to enter the app again, leading to reference point 601 in FIG. 10 and then the same reference point 601 in FIG. 6. Otherwise, if a milestone has been reached, then after incrementing the trip tally or electronic ledger by one, the mobile electronic device can receive a push notification regarding the milestone, and the user can tap the push notification to enter the app, after which the user interface of the app on the mobile electronic device can display a full-screen-takeover with a milestone celebration. After tapping on the full-screen-takeover, the user interface of the app displays the home screen of the app with a watch face showing the trip streak or electronic ledger, along with driving scores for distraction-free driving, driving patterns, safe speeds, and smooth driving, and their respective trends. Then, the user can tap the “What's this?” or equivalent link or button to display information about streaks. Next, the user can tap the back arrow for the graphical user interface of the app to display the default watch face design showing the current discount for the monthly vehicle insurance premium, which leads to the decision diamond in FIG. 10 regarding whether (another) streak milestone has been reached.

As shown in FIG. 10, the graphical user interfaces can display: the home screen of the graphical user interface for the mobile electronic device, the push notification for celebrating the streak milestone, the full-screen-takeover of the app for celebrating the streak milestone, the watch face design of the app indicating the streak count or electronic ledger, the additional information about streaks, and the default watch face design of the app showing the current discount for the monthly vehicle insurance premium.

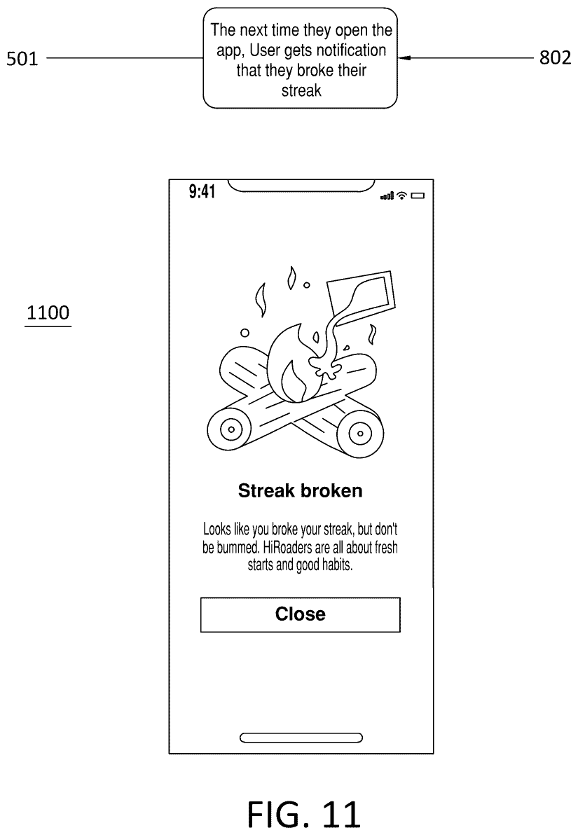

FIG. 11 illustrates a seventh portion of the exemplary flow chart and related exemplary displayed content on the graphical user interface of the mobile electronic device, according to the exemplary embodiment of FIG. 5. The displayed content is merely exemplary and is not limited to the embodiments presented herein. The displayed content can be employed in many different embodiments or examples not specifically depicted or described herein. In a number of embodiments, the displayed content can include a graphical user interface for an app on the mobile electronic device, similar to the app and mobile electronic device described above with reference to FIGS. 3 and 4. In some embodiments, the graphical user interfaces and/or portions thereof of the displayed content can be arranged in the layout presented in FIG. 5. In other embodiments, the graphical user interfaces and/or portions thereof of the displayed content can be arranged in any suitable layouts. In still other embodiments, one or more of the graphical user interfaces and/or the portions of the displayed content can be combined or omitted. In many embodiments, system 300 (FIG. 3), system 310 (FIG. 3), or method 400 (FIG. 4) can be suitable to generate, transmit, and/or display or cause to display the graphical user interfaces and/or any portions thereof.

As an example, FIG. 11 can show the end of a streak or a broken streak. More specifically, starting from reference point 802 in FIG. 11, the next time the user opens the app on the mobile electronic device, the graphical user interface of the app shows a notification that the streak has ended or is broken (e.g., a streak-loss notification), which leads to reference point 501 in FIG. 11, which is the same reference point 501 in FIG. 5.

### Further Embodiments of Methods, Flow Charts, and Graphical User Interfaces for Reducing Mobile Device Usage by a Driver of a Vehicle

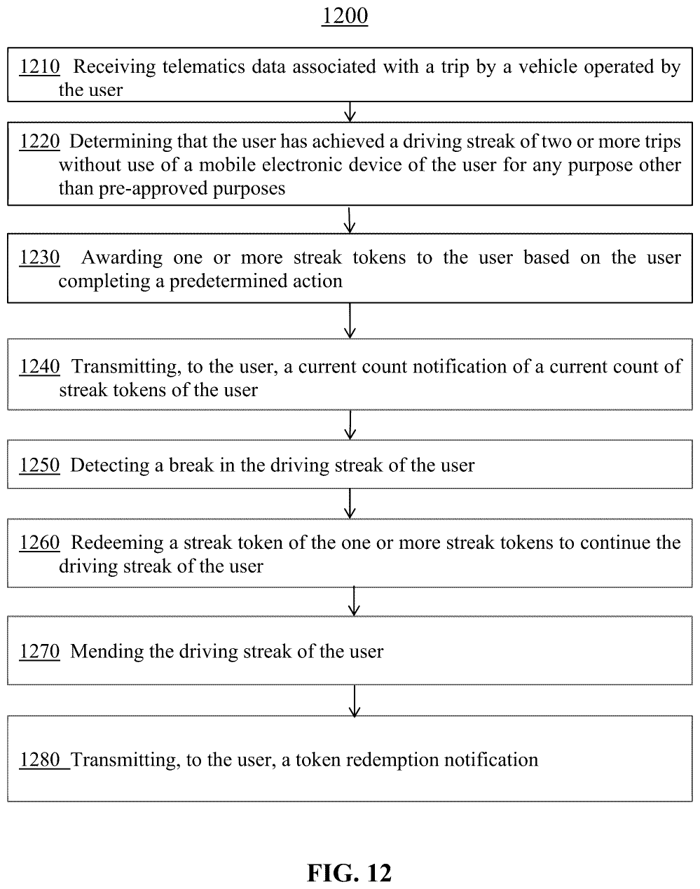

Continue with the next drawing, FIG. 12 illustrates a flow chart of a method 1200 of earning and using streak tokens, according to an embodiment. Method 1200 can track the use of mobile electronic devices by a person while driving a vehicle, reducing such use by the person, motivating the person to reduce such use, reducing distracted driving by the person, and/or motivating the person to reduce distracted driving, according to certain embodiments. Method 1200 also can be used, in some embodiments, to motivate a user to continue a driving streak of not using the user's mobile electronic device for any purpose other than pre-approved purposes while operating a vehicle during a trip, where the motivation is introduced to the user after the user commits an act or omission that breaks the driving streak. More specifically, a user can earn a streak token in various ways, and if the user breaks her driving streak, then the user can use the streak token to boost or mend the driving streak such that the driving streak is maintained and is not reset to zero or the beginning, which can be demotivating for a user to continue her safe driving pattern.

Method 1200 can be implemented via execution of computing instructions configured to run on one or more processors and stored on one or more non-transitory computer-readable media. Method 1200 is exemplary and is not limited to the embodiments presented herein. Method 1200 can be employed in many different embodiments or examples not specifically depicted or described herein. In some embodiments, the procedures, the processes, the operations, the actions, and/or the activities of method 1200 can be performed in the order presented. In other embodiments, the procedures, the processes, the operations, the actions, and/or the activities of method 1200 can be performed in any suitable order. In still other embodiments, one or more of the procedures, the processes, the operations, the actions, and/or the activities of method 1200 can be combined or skipped.

In many embodiments, system 300 or system 310 (FIG. 3) (including one or more of its elements, modules, and/or systems, such as telematics module 31410, determination module 31420, ledger module 31430, etc.) can be suitable to perform method 1200 and/or one or more of the operations, actions, and/or activities of method 1200. In these or other embodiments, one or more of the operations, actions, and/or activities of method 1200 can be implemented as one or more computing instructions configured to run on one or more processors and configured to be stored on one or more non-transitory computer readable media. Such non-transitory computer readable media can be part of a computer system such as system 300, system 310, remote server(s) 320, and/or user device(s) 350. The processor(s) can be similar or identical to the processor(s) described above with respect to computer system 100 (FIG. 1).

Referring to FIG. 12, method 1200 can include a block 1210 of receiving telematics data for a vehicle and/or associated with a trip by a vehicle operated by the user. In some embodiments, block 1210 of method 1200 of FIG. 12 can be similar to block 410 of method 400 in FIG. 4. In the same or different embodiments, the telematics data of block 1210 in FIG. 12 can be transmitted by a mobile electronic device (e.g., one of user device(s) 350 (FIG. 3)) of a user who is driving a vehicle. In these embodiments, the user can authorize an app on the mobile electronic device to use sensors (e.g., GPS sensors) on the mobile electronic device to collect the telematics data during a vehicle trip. The user can authorize the app to use the sensors to collect the telematics data before the vehicle trip begins or at the beginning of the vehicle trip. In other embodiments, the app automatically uses the sensors to collect the telematics data during the vehicle trip, and does not require the user to authorize the app to do so. In still other embodiments, the telematics data can be transmitted by the vehicle being driven by the user. Regardless of the source of the telematics data, the telematics data can be received directly from the source or indirectly from the source through the Internet and/or a cellular network. The telematics data can include GPS data such as speed, acceleration, deceleration, elevation, incline, decline, etc.

In many embodiments, after block 1210, method 1200 further can include a block 1220 of determining that the user has achieved a driving streak of two or more trips without use of a mobile electronic device of the user for any purpose other than pre-approved purposes during the two or more trips. As an example, the determining step can be based on the telematics data of block 1210. In some embodiments, block 1220 of method 1200 in FIG. 12 can be similar to blocks 420, 430, 440, 450, and 460 of method 400 in FIG. 4. Accordingly, the explanation of the pre-approved purposes described above with reference to block 430 in FIG. 4 can apply here to block 1220 of FIG. 12. In the same or different embodiments, block 1220 of method 1200 in FIG. 12 also can include block 470 of method 400 in FIG. 4.

After block 1220 in method 1200 in FIG. 12, method 1200 can continue with a block 1230 of awarding one or more streak tokens to the user. In some embodiments, the awarding of block 1230 can be based on, in response to, and/or triggered by the user completing a predetermined action. As explained herein, a streak token can be used to boost or mend a break in a user's driving streak to motivate the user to continue the user's driving streak after the user breaks the driving streak.

In some embodiments, method 1200 can use a single type of streak token and/or different types of streak tokens, and when using different types of streak tokens, method 1200 can have different requirements for a user to earn the different types of streak tokens. For example, when method 1200 uses different types of streak tokens, method 1200 can use a first type of streak token to boost or mend a break in a driving streak caused by a single trip (i.e., a single trip where the user used the user's mobile electronic device for a purpose other than pre-approved purposes), a second type of streak token to boost or mend a break in the driving streak caused by two successive trips, and a third type of streak token to boost or mend a break in the driving streak caused by three or more successive trips. In this example, the requirements for a user to earn a streak token to boost or mend a break in the driving streak caused by a single trip can be easier to meet than the requirements for a user to earn a streak token to boost or mend a break in the driving streak caused by two successive trips, and so on. In the same or different embodiment, when method 1200 uses different types of streak tokens, method 1200 can use different types of streak tokens to boost or mend one or more breaks in a driving streak occurring during a single hour (e.g., regardless of how many trips were taken during the single hour), during two consecutive hours, and during three or more consecutive hours. In this example, the requirements for a user to earn a streak token to boost or mend one or more breaks in the driving streak occurring during a single hour can be easier to meet than the requirements for a user to earn a streak token to boost or mend one or more breaks in the driving streak occurring during two successive hours, and so on. Furthermore, in the same or different embodiment, when method 1200 uses different types of streak tokens, method 1200 can use different types of streak tokens to boost or mend a break in a driving streak occurring during a single day (e.g., regardless of how many trips were taken during the single day), during two consecutive days, and during three or more consecutive days. In this example, the requirements for a user to earn a streak token to boost or mend one or more breaks in the driving streak occurring during a single day can be easier to meet than the requirements for a user to earn a streak token to boost or mend one or more breaks in the driving streak occurring during two consecutive days, and so on. In a different embodiment, method 1200 can use a single type of streak token to boost or mend a break in a driving streak, regardless of how many successive trips, hours, or days the break lasts.

In some embodiments, the awarding the one or more streak tokens to the user based on the user completing the predetermined action of block 1230 in FIG. 12 can include determining that the user has completed an activity within the app. For example, an activity within the app can include sharing a referral to use the app (and/or to enroll in an insurance policy that encourages or requires use of the app) with a friend, family member, or other contact, where the person signs up to use the app (and/or signs up for the insurance policy). As another example, an activity within the app can include setting certain permissions within the app, such as permit the app to track the driving of user. As a further example, an activity within the app can include a hidden task (i.e., an caster egg). As an additional example, an activity within the app can include a renewal of a subscription for the app and/or an insurance policy that encourages or requires use of the app. As another example, an activity within the app can include the user viewing a monthly driving recap in the app (e.g., to educate the user on how to improve the user's safe driving habits).

As a further example, an activity within the app can include a determination that the user's driving score exceeds a threshold driving score to qualify the user for an additional streak token. In this example, block 1230 can include determining a driving score based on the telematics data, and awarding a first streak token based on the driving score.

As yet another example, an activity within the app can include completing a challenge in the app. As an example, the challenge can include successfully answering questions relating to a challenge scenario about safe driving. In further embodiments, this example can include winning a competition of completing safe driving questionnaires, in-app challenges, and so on against other users of the app. In related embodiments, an activity within the app can include earning a predetermined number of points from different challenges and/or completing a series safe driving questionnaires in the app and/or of in-app challenges, completing all available safe driving questionnaires in the app and/or in-app challenges, and/or completing a series of safe driving questionnaires and/or in-app challenges. The challenge also can include completing a safe driving questionnaire in the app, such as a myth busting quiz or a chill driver quiz. As an example of a myth busting quiz, the user can answer questions such as “To merge safely, enter into highway traffic at least 20 miles per hour faster than other cars. True or False?” or “If your car starts to hydroplane, ease off the gas and steer into the direction you are sliding. True or False?”. As an example of a chill driver quiz, the user can answer questions such as “Most drivers are least distracted during which time frame? 5-8 am, 6-9 am, 4-7 pm, or 8-10 pm” or “Your crash risk doubles when you look away for how long? 2 seconds, 3 seconds, 5 seconds, or 7 seconds”.

In other examples, an activity within the app can include the user completing or reaching a milestone. In this example, block 1230 can include making a determination that the user has completed a milestone, and awarding a first streak token in response to the determination. In general, the milestone can be an interval of time or an interval of successive, successful trips. In some embodiments, the milestone can be a threshold length of the driving streak and/or a predetermined number of successive trips without use of the driver's mobile electronic device for any purposes other than pre-approved purposes during the successive trips. For example, in some embodiments, each time a user reaches 10, 25, 50, or 100 successive, successful trips, then the user can earn and be awarded one or more additional streak tokens. As another example, when a user reaches a 3-month, 6-month, or annual anniversary of using the app, then the user can earn and be awarded one or more additional streak tokens.

In some embodiments, the awarding of block 1230 in FIG. 12 can include awarding streak tokens at different rates based on a length of the driving streak. For example, if a user has been using the app to track driving streaks for 12 months and if the user has a current driving streak of at least 30, then method 1200 can award streak tokens at rate that is ten percent faster in terms of milestones than when the user first started using the app to track driving streaks.

After block 1230, method 1200 in FIG. 12 can include a block 1240 of transmitting, to the user, a current count notification of a current count of streak tokens of the user. As an example, the current count notification can be transmitted via a user interface of a mobile device of the user after the one or more streak tokens are awarded to the user. As an example, the user interface can be of the app referenced in block 1230. The current count notification can be (a) an in-app message that appears on the user interface of the app, (b) a push notification that appears as an alert or card on the home screen of the mobile electronic device of the user, and/or (c) an email or text message that appears on a different app of the mobile electronic device of the user.

Next, after block 1240, method 1200 in FIG. 12 can include a block 1450 of detecting a break in the driving streak of the user. The break can be trip-based, such as a single trip, three trips in a row, etc., or the trip can be time-based, such as one or more distracted driving trips in a single hour or day, etc. In some embodiments, block 1450 can include determining that a single trip occurred during which the mobile electronic device of the user was used for a purpose other than the pre-approved purposes, wherein the single trip was for a vehicle operated by the user. In other embodiments, block 1450 can include determining that a trip was incorrectly classified as a driving trip for the user where the user was considered to be the driver of the vehicle used for the driving trip, and then restoring the driving streak for the user without redeeming a streak token of the user.

Subsequently, method 1200 in FIG. 12 can continue with a block 1260 of redeeming at least one streak token of the one or more streak tokens of the user. The redeeming of block 1260 can be active or passive. When active, the redeeming can include receiving feedback or input from the user to use the at least one streak token to boost or mend the broken driving streak. When passive, the redeeming can include an automatic redemption process to use at least one streak token to boost or mend the broken driving streak. When the redeeming is passive, the redemption can be based on circumstances or conditions preset by the user. In some embodiments, the redeeming of block 1260 can be passive or automatic, unless the user opts out of the passive or automatic redemption by clicking or tapping a button on the user interface of the app such that the user must later click or tap another button after the user breaks a driving streak to use or redeem a streak token to boost or mend the driving streak.

In some embodiments, block 1260 can redeem one or more streak tokens at a time for a trip-based break (e.g., a one-trip break, a two-trip break, etc.) or time-based break (e.g., a one-hour break, a two-hour break, a one-day break, a two-day break, etc.) in the driving streak. In other embodiments, block 1260 can redeem one or more streak tokens at a time for a consecutive series of trip breaks or day breaks that are bookended by driving streaks, one or more non-distracted driving trips, or one or more non-distracted driving days (with or without a limit on the length of the break that is bookended). In other embodiments, block 1260 can redeem one or more streak tokens at a time for an app session break (i.e., time spent between app visits, uses, or openings). In further embodiments, block 1260 can redeem one or more streak tokens using a just-in-time redemption process where the streak token(s) are redeemed immediately upon being earned or awarded in block 1230. In still other embodiments, block 1260 can pre-redeem one or more streak tokens when the user predicts or knows that she will be (a) breaking her driving streak (i.e., vacation mode; when the user is driving outside of the user's typical location; etc.), (b) in a vehicle as a passenger (i.e., passenger mode).

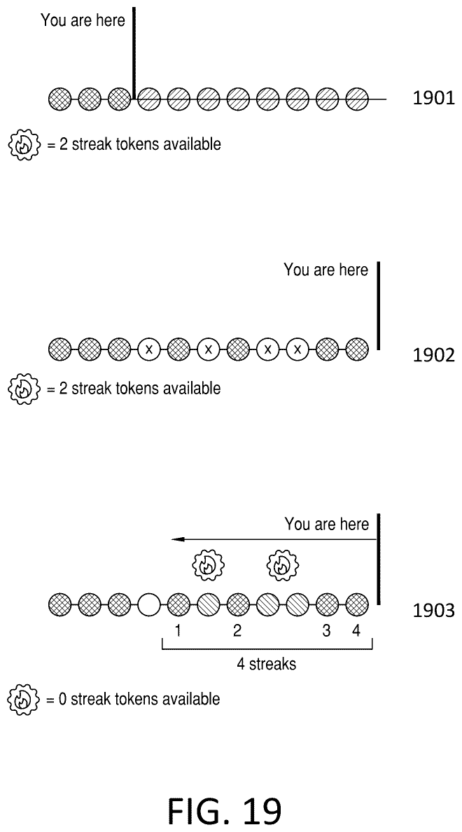

Next, after block 1260, method 1200 in FIG. 12 can continue with a block 1270 of mending the driving streak of the user. As an example, the mending of block 1270 can use the at least one streak token redeemed in block 1260. In some embodiments, block 1270 can include applying the at least one streak token to bridge a gap in the driving streak (or to boost the driving streak) of the user caused by a single trip or multiple trips, so that the driving streak can continue or be restored. In other embodiments, block 1270 can include applying the at least one streak token to pause the app for a trip, a set of trips, or a period of time. In some embodiments, as explained with reference to FIG. 19 below, block 1270 can boost or mend the driving streak all the way back to the immediately previous app start if the user has a high enough quantity of streak tokens.

Continuing with FIG. 12, method 1200 can continue with a block 1280 of transmitting a token redemption notification to the user. As an example, the token redemption notification can be transmitted via a user interface of a mobile device of the user after the streak token is redeemed and used to mend the driving streak of the user. As an example, the user interface can be of the app referenced in blocks 1230 and 1240. The token redemption notification can be (a) an in-app message that appears on the user interface of the app, (b) a push notification that appears as an alert or card on the home screen of the mobile electronic device of the user, and/or (c) an email or text message that appears on a different app of the mobile electronic device of the user. In some embodiments, block 1280 can occur between blocks 1260 and 1270, instead of after block 1270.

Although not shown in FIG. 12, method 1200 also can include receiving one or more streak tokens from the user to be provided to one or more other users. In this embodiment of method 1200, a marketplace can be established for the user to buy/sell, exchange, or trade streak tokens. In the same or different embodiment, method 1200 also can include a decay mechanism for (a) streak tokens that are earned and awarded, but are not used within a predetermined period of time, or (b) a quantity of streak tokens that exceed a predetermined threshold.

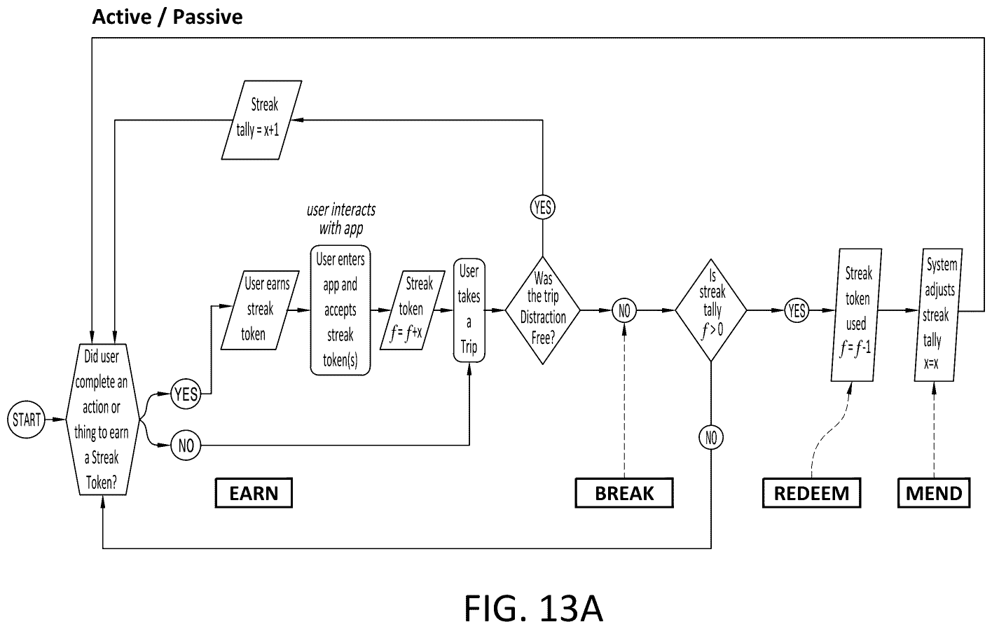

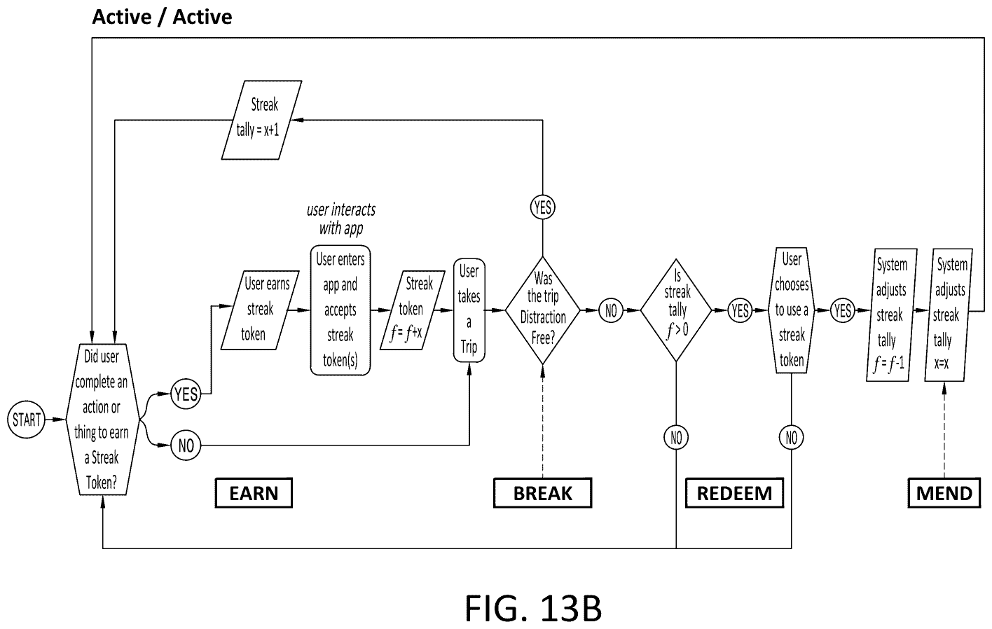

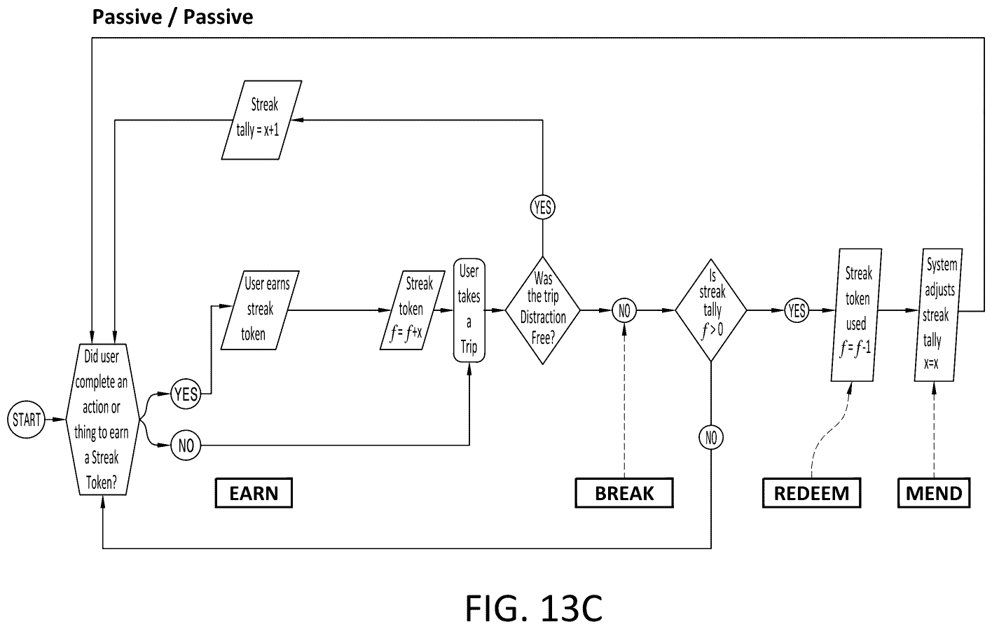

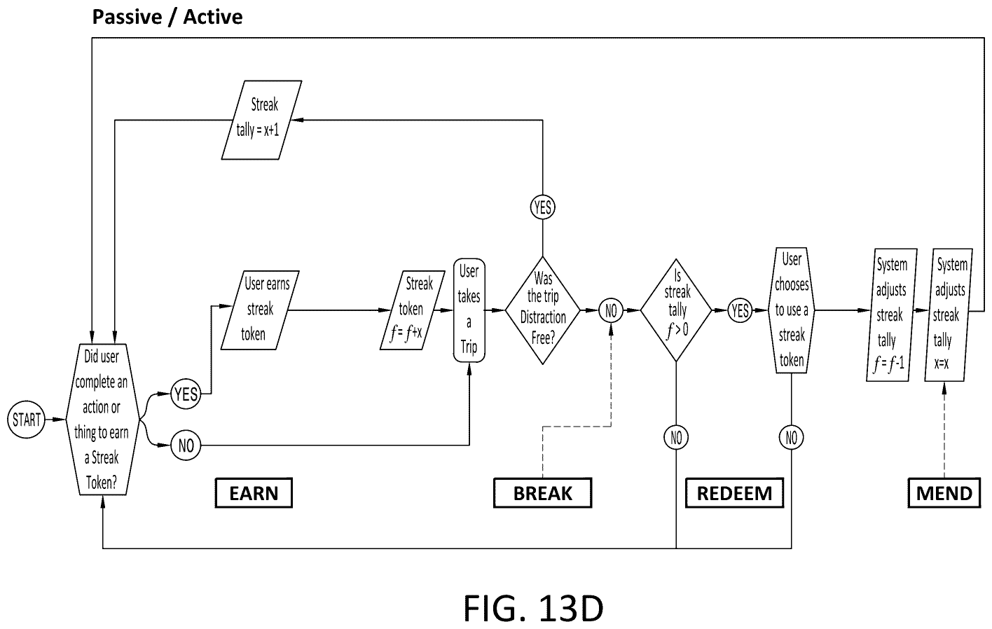

Turning to the next drawings, FIGS. 13A-13D illustrate flow charts for system flows, according to an embodiment. The flow charts can show system flows for a portion of method 1200 in FIG. 12. More specifically, the flow charts in FIGS. 13A-13D can show different flow diagrams for actions similar to blocks 1220, 1230, 1250, 1260, and 1270 in FIG. 12.

The flow charts in FIGS. 13A-13 D can be implemented via execution of computing instructions configured to run on one or more processors and stored on one or more non-transitory computer-readable media. The flow charts are exemplary and are not limited to the embodiments presented herein. The flow charts can be employed in many different embodiments or examples not specifically depicted or described herein. In some embodiments, the procedures, the processes, the operations, the actions, and/or the activities of the flow charts can be performed in the order presented. In other embodiments, the procedures, the processes, the operations, the actions, and/or the activities of the flow charts can be performed in any suitable order. In still other embodiments, one or more of the procedures, the processes, the operations, the actions, and/or the activities of method 1200 can be combined or skipped.

In many embodiments, system 300 or system 310 (FIG. 3) (including one or more of its elements, modules, and/or systems, such as determination module 31420, ledger module 31430, etc.) can be suitable to perform the flow chart and/or one or more of the operations, actions, and/or activities of the flow chart. In these or other embodiments, one or more of the operations, actions, and/or activities of the flow chart can be implemented as one or more computing instructions configured to run on one or more processors and configured to be stored on one or more non-transitory computer readable media. Such non-transitory computer readable media can be part of a computer system such as system 300, system 310, remote server(s) 320, and/or user device(s) 350. The processor(s) can be similar or identical to the processor(s) described above with respect to computer system 100 (FIG. 1).

Referring to FIG. 13A, the flow chart shows an active earn and passive redemption process. Specifically, the flow chart in FIG. 13A can include determining whether a user completed an action or thing to earn one or more streak tokens. If the user did so, then the user earns one or more streak tokens and interacts with the app to affirmatively accept the one or more streak tokens, the streak token count is increased by one or more, and then the user takes a trip. If the user did not complete the action or thing to earn one or more streak tokens, then the user takes the trip. Next, the flow chart continues with determining whether the trip was distraction free (e.g., did the trip occur without use of the mobile electronic device of the driver for any purpose other than the pre-approved purposes). If the trip was determined to be distraction free, then the flow chart increases the driving streak count by one, and repeats determining whether a user completed an action or thing to earn one or more streak tokens, and so on. If the trip was determined to not be distraction free, then a break in the driving streak occurs, the driving streak count is set to zero, and the flow chart checks whether the streak token count is greater than zero. If the streak token count is not greater than zero, then the driving streak remains at zero, and the flow chart repeats determining whether a user completed an action or thing to earn one or more streak tokens, and so on. If the streak token count is greater than zero, then the flow chart redeems one or more streak tokens, subtracts one or more from the streak token count, boosts or mends the driving streak count from zero back to where the driving streak count was, and then repeats determining whether a user completed an action or thing to earn one or more streak tokens, and so on.

Referring to FIG. 13B, the flow chart shows an active earn and active redemption process. Specifically, the flow chart in FIG. 13B can include determining whether a user completed an action or thing to earn one or more streak tokens. If the user did so, then the user earns one or more streak tokens and interacts with the app to affirmatively accept the one or more streak tokens, the streak token count is increased by one or more, and then the user takes a trip. If the user did not complete the action or thing to earn one or more streak tokens, then the user takes the trip. Next, the flow chart continues with determining whether the trip was distraction free (e.g., did the trip occur without use of the mobile electronic device of the driver for any purpose other than the pre-approved purposes). If the trip was determined to be distraction free, then the flow chart increases the driving streak count by one, and repeats determining whether a user completed an action or thing to earn one or more streak tokens, and so on. If the trip was determined to not be distraction free, then a break in the driving streak occurs, the driving streak count is set to zero, and the flow chart checks whether the streak token count is greater than zero. If the streak token count is not greater than zero, then the driving streak remains at zero, and the flow chart repeats determining whether a user completed an action or thing to earn one or more streak tokens, and so on. If the streak token count is greater than zero, then the flow chart requests the user to decide whether to redeem one or more streak tokens. If the user decides to not redeem one or more streak tokens, then the driving streak remains at zero, and the flow chart repeats determining whether a user completed an action or thing to earn one or more streak tokens, and so on. If the user decides to redeem one or more streak tokens, then the flow chart redeems one or more streak tokens, subtracts one or more from the streak token count, boosts or mends the driving streak count from zero back to where the driving streak count was, and then repeats determining whether a user completed an action or thing to earn one or more streak tokens, and so on.

Referring to FIG. 13C, the flow chart shows a passive earn and passive redemption process. Specifically, the flow chart in FIG. 13C can include determining whether a user completed an action or thing to earn one or more streak tokens. If the user did so, then the user earns one or more streak tokens, the streak token count is increased by one or more, and then the user takes a trip. If the user did not complete the action or thing to earn one or more streak tokens, then the user takes the trip. Next, the flow chart continues with determining whether the trip was distraction free (e.g., did the trip occur without use of the mobile electronic device of the driver for any purpose other than the pre-approved purposes). If the trip was determined to be distraction free, then the flow chart increases the driving streak count by one, and repeats determining whether a user completed an action or thing to earn one or more streak tokens, and so on. If the trip was determined to not be distraction free, then a break in the driving streak occurs, the driving streak count is set to zero, and the flow chart checks whether the streak token count is greater than zero. If the streak token count is not greater than zero, then the driving streak remains at zero, and the flow chart repeats determining whether a user completed an action or thing to earn one or more streak tokens, and so on. If the streak token count is greater than zero, then the flow chart redeems one or more streak tokens, subtracts one or more from the streak token count, boosts or mends the driving streak count from zero back to where the driving streak count was, and then repeats determining whether a user completed an action or thing to earn one or more streak tokens, and so on.

Referring to FIG. 13D, the flow chart shows a passive earn and active redemption process. Specifically, the flow chart in FIG. 13D can include determining whether a user completed an action or thing to earn one or more streak tokens. If the user did so, then the user earns one or more streak tokens, the streak token count is increased by one or more, and then the user takes a trip. If the user did not complete the action or thing to earn one or more streak tokens, then the user takes the trip. Next, the flow chart continues with determining whether the trip was distraction free (e.g., did the trip occur without use of the mobile electronic device of the driver for any purpose other than the pre-approved purposes). If the trip was determined to be distraction free, then the flow chart increases the driving streak count by one, and repeats determining whether a user completed an action or thing to earn one or more streak tokens, and so on. If the trip was determined to not be distraction free, then a break in the driving streak occurs, the driving streak count is set to zero, and the flow chart checks whether the streak token count is greater than zero. If the streak token count is not greater than zero, then the driving streak remains at zero, and the flow chart repeats determining whether a user completed an action or thing to earn one or more streak tokens, and so on. If the streak token count is greater than zero, then the flow chart requests the user to decide whether to redeem one or more streak tokens. If the user decides to not redeem one or more streak tokens, then the driving streak remains at zero, and the flow chart repeats determining whether a user completed an action or thing to earn one or more streak tokens, and so on. If the user decides to redeem one or more streak tokens, then the flow chart redeems one or more streak tokens, subtracts one or more from the streak token count, boosts or mends the driving streak count from zero back to where the driving streak count was, and then repeats determining whether a user completed an action or thing to earn one or more streak tokens, and so on.

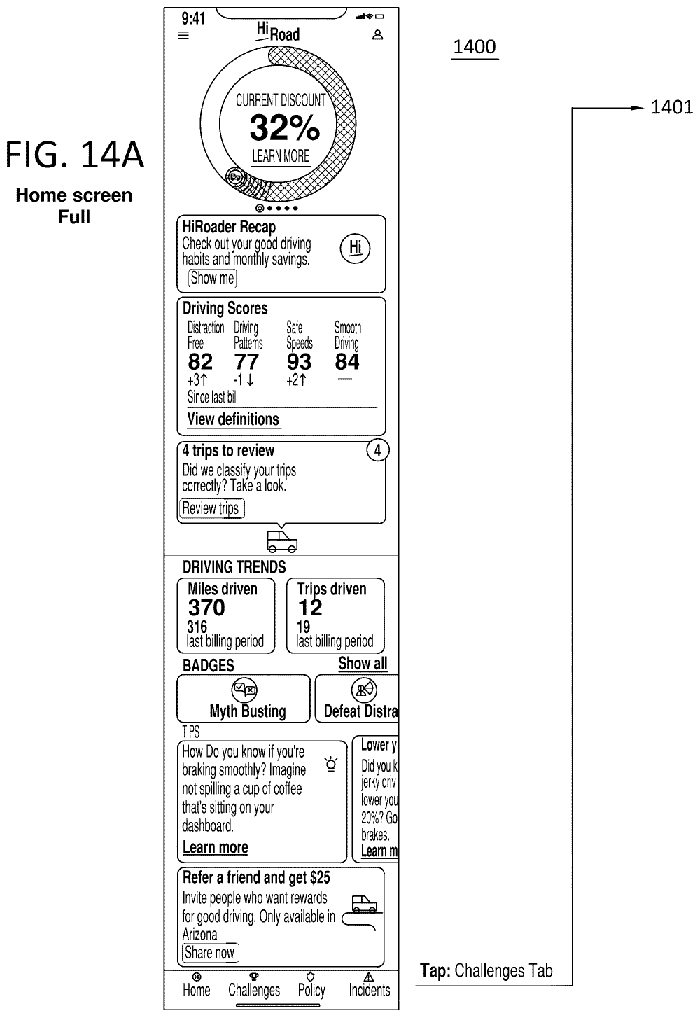

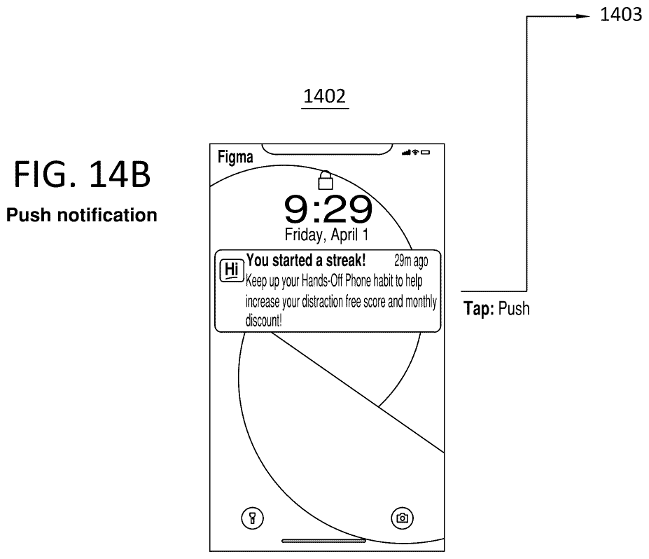

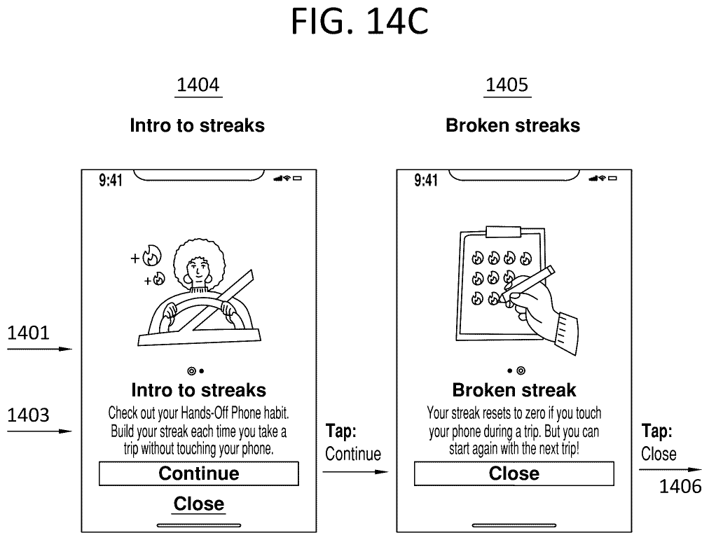

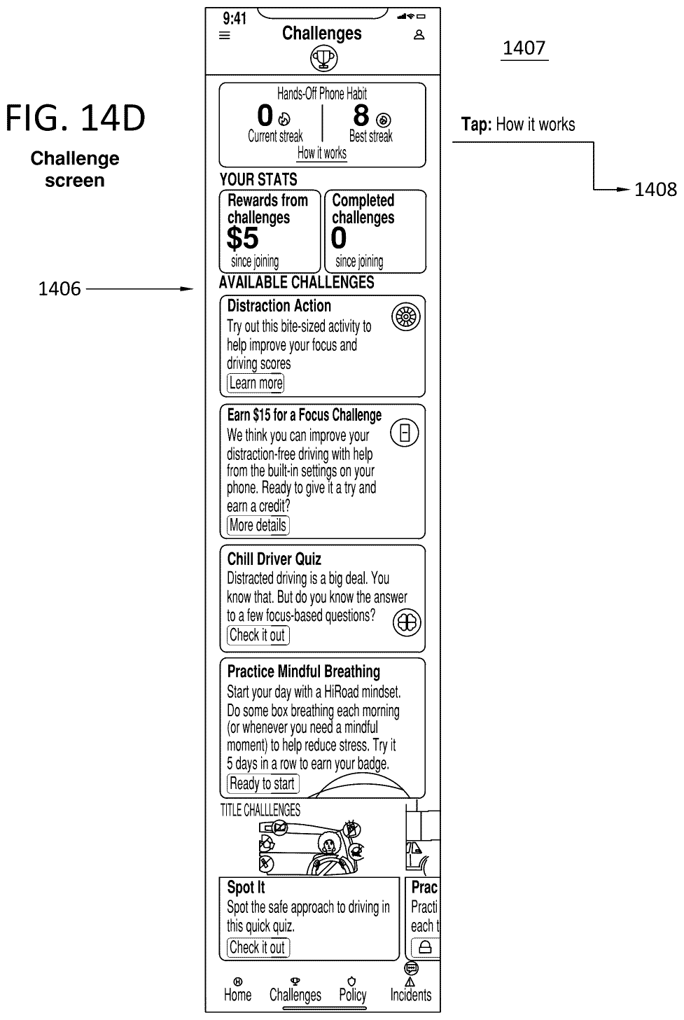

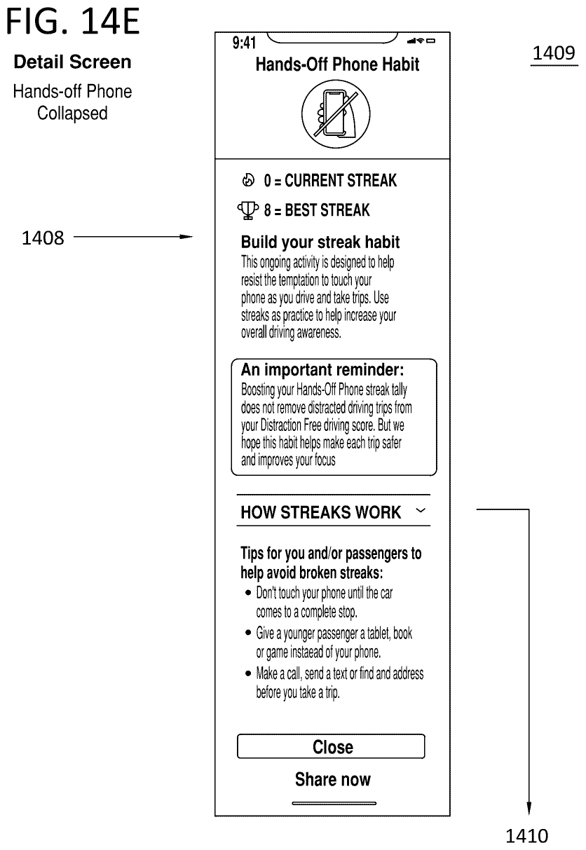

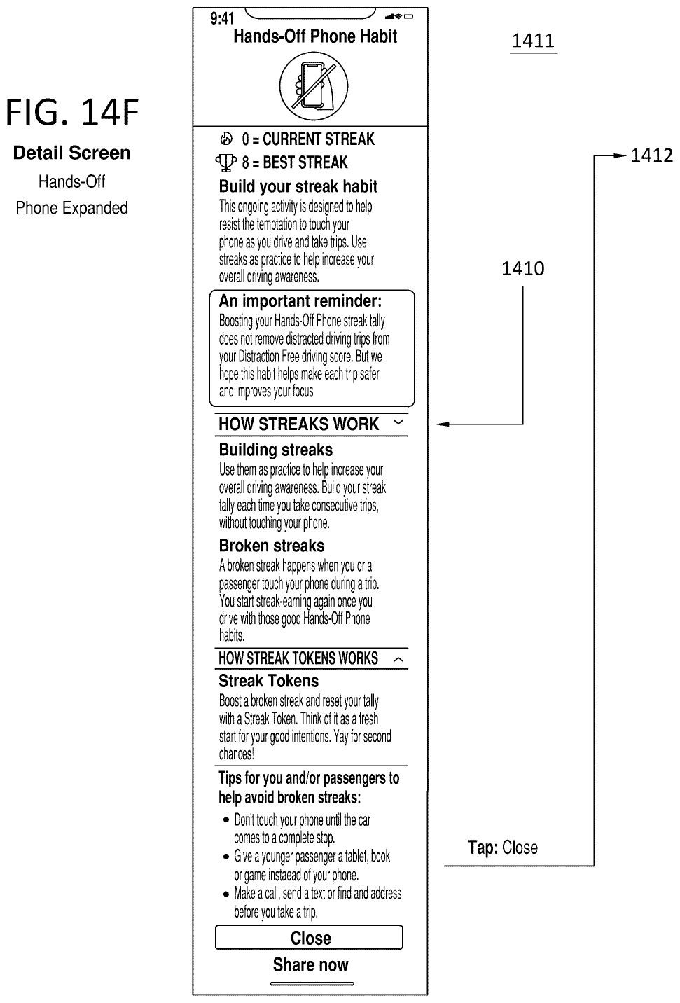

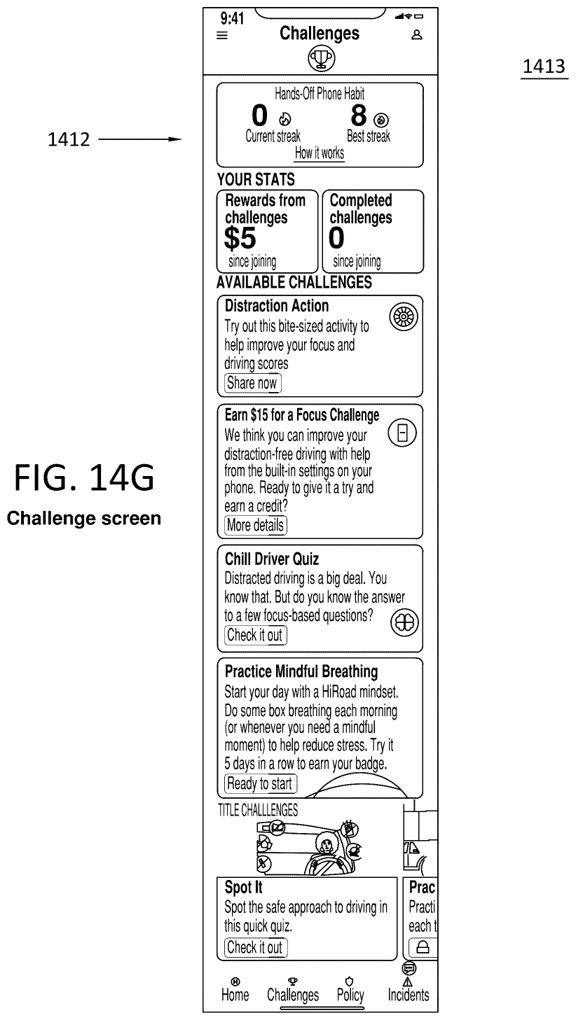

Turning ahead in the drawings, FIGS. 14A-14G, 15A-15G, 16A-16D, 17, and 18A-18F illustrate different portions of a flow chart and related displayed content on a graphical user interface of a mobile electronic device, according to an embodiment. The flow chart and displayed content can be used for, in various embodiments, tracking the use of mobile electronic devices by a person while driving a vehicle, reducing such use by the person, motivating the person to reduce such use, reducing distracted driving by the person, and/or motivating the person to reduce distracted driving. The flow chart and displayed content also can be used for, in some embodiments, to motivate a user to continue a driving streak of not using the user's mobile electronic device for any purpose other than pre-approved purposes while operating a vehicle during a trip, where the motivation is introduced to the user after the user commits an act or omission that breaks the driving streak. More specifically, a user can earn a streak token in various ways, and if the user breaks her driving streak, then the user can use the streak token to boost or mend the driving streak such that the driving streak is maintained and is not reset to zero or the beginning, which can be demotivating for a user to continue her safe driving pattern.

More specifically FIGS. 14A-14G illustrate a first portion of the flow chart and related displayed content displayed on a graphical user interface of a mobile electronic device, according to an embodiment. The displayed content is an embodiment and is not limited to the embodiments presented herein. The displayed content can be employed in many different embodiments or examples not specifically depicted or described herein. In a number of embodiments, the displayed content can include a graphical user interface for an app on the mobile electronic device, similar to the app and mobile electronic device described above with reference to FIGS. 12 and 13. In some embodiments, the graphical user interfaces and/or portions thereof of the displayed content can be arranged in the layout presented in FIGS. 14A-14G. In other embodiments, the graphical user interfaces and/or portions thereof of the displayed content can be arranged in any suitable layouts. In still other embodiments, one or more of the graphical user interfaces and/or the portions of the displayed content can be combined or omitted. In many embodiments, system 300 (FIG. 3), system 310 (FIG. 3), or method 400 (FIG. 4) can be suitable to generate, transmit, and/or display or cause to display the graphical user interfaces and/or any portions thereof.

As an example, FIGS. 14A-14G can show an introduction to driving streaks. More specifically, in some embodiments, starting from the home screen 1400 of the app (FIG. 14A), a user can click or tap 1401 the “Challenges” button at the bottom of the screen for the first time after having begun a streak to view a “Intro to streaks” screen 1404 (FIG. 14C) of the app to review information about streaks. In other embodiments, starting from a locked home screen 1402 of the smartphone (FIG. 14B), the user can click or tap 1403 the “You started a streak!” push notification to view, for the first time after having begun a streak, the “Intro to streaks” screen 1404 (FIG. 14C) of the app to review information about streaks. The home screen 1400 of the app (FIG. 14A) can show information about the user's current discount of a vehicle insurance policy, a recap of the user's good driving habits and monthly savings, the user's driving scores, verification of the user's recent trips as a driver, the user's driving trends, the user's in-app badges, driving tips and advice, referral opportunities, and so on.

From the “Intro to streaks” screen 1404 (FIG. 14C) of the app, the user can click or tap a “Continue” button to view a “Broken streaks” screen (FIG. 14C) of the app to view information about breaking a streak, and then the user can click or tap 1406 a “Close” button to view a “Challenges” screen 1407 (FIG. 14D) of the app. The “Challenges” screen 1407 (FIG. 14D) of the app can show information about the user's current streak (which is currently zero), the user's best streak so far (which is currently eight), the user's rewards from challenges (which is currently five dollars), the user's completed challenges (which is currently zero), the user's available challenges (e.g., “Distraction Action,” “Focus Challenge,” “Chill Driver Quiz,” Mindful Breathing,” “Title Challenges,” and so on.

Next, the user can click or tap 1408 on the “How it works” link on the “Challenges” screen 1407 (FIG. 14D) to view a “Hands-Off Phone Habit” screen 1409 (FIG. 14E) to view information about the user's current streak (which is currently zero), the user's best streak so far (which is currently eight), and how to increase the user's driving streak, among other information. From the “Hands-Off Phone Habit” screen 1409 (FIG. 14E), the user can click or tap 1410 on the “HOW STREAKS WORK” section to view the “HOW STREAKS WORK” information 1411 (FIG. 14F). Next, the user can click or tap 1412 the “Close” button on the “Hands-Off Phone Habit” screen to show the “Challenges” screen 1413 (FIG. 14G).

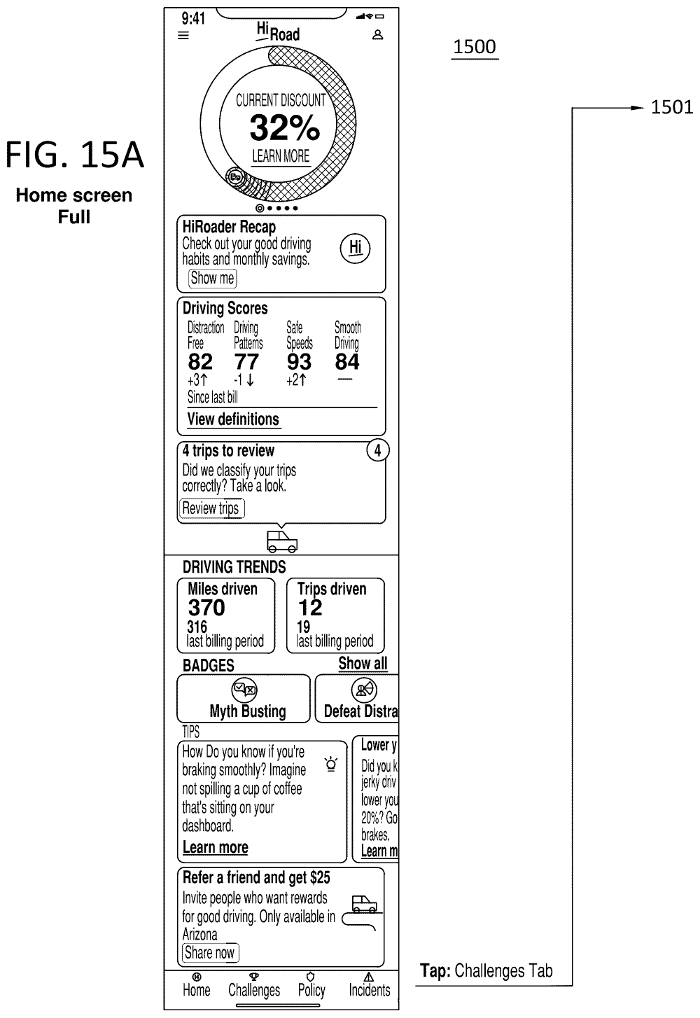

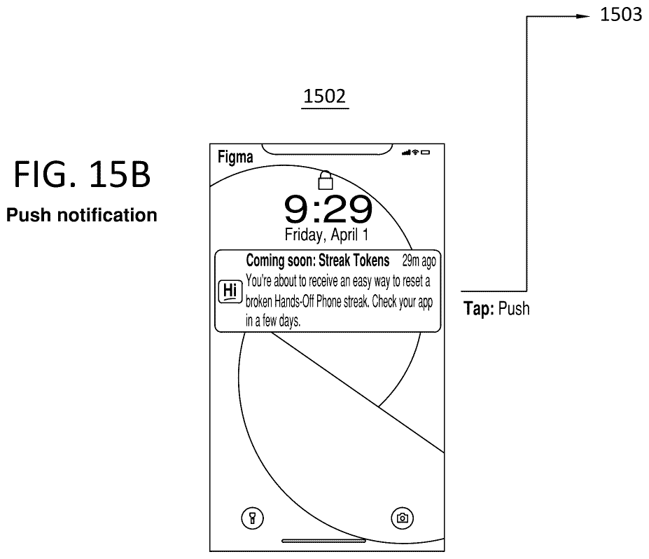

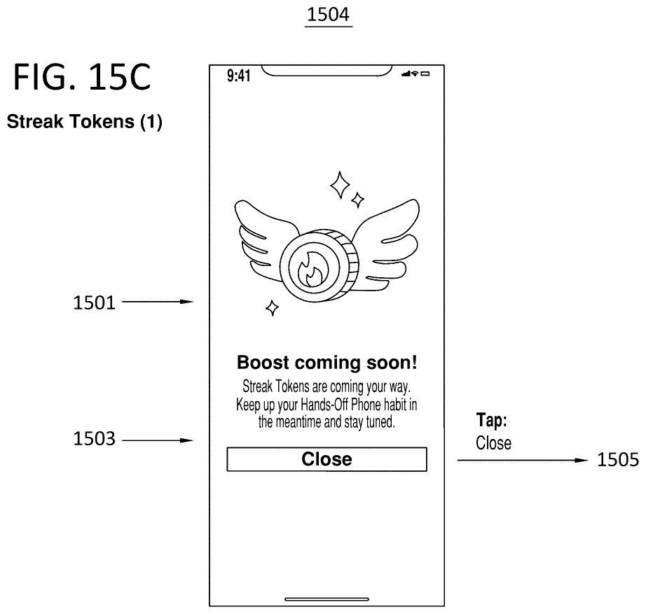

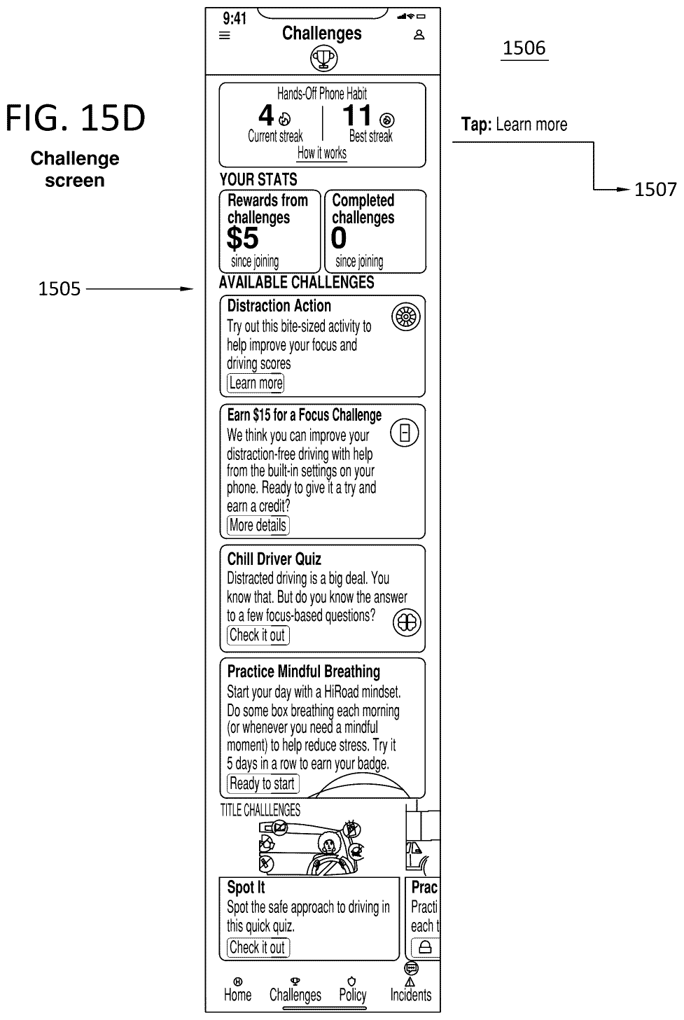

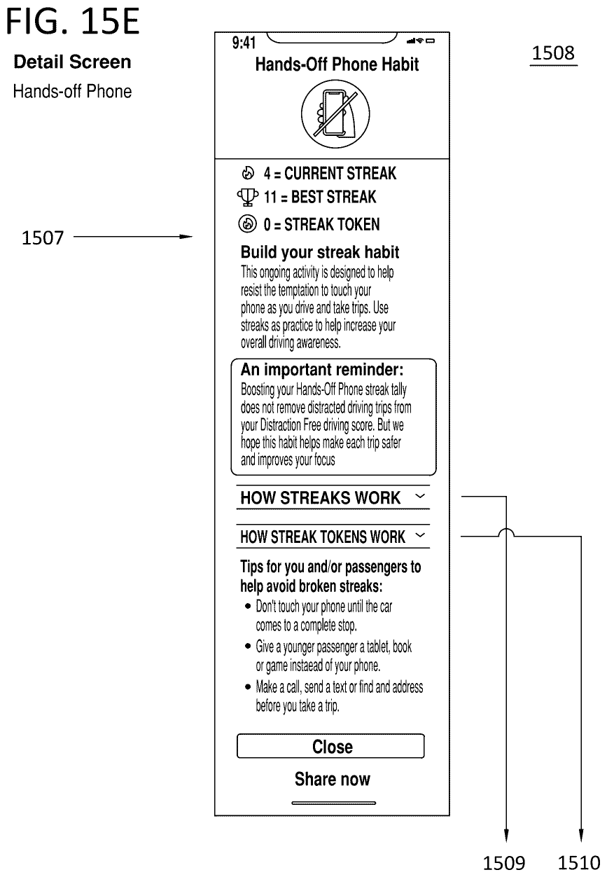

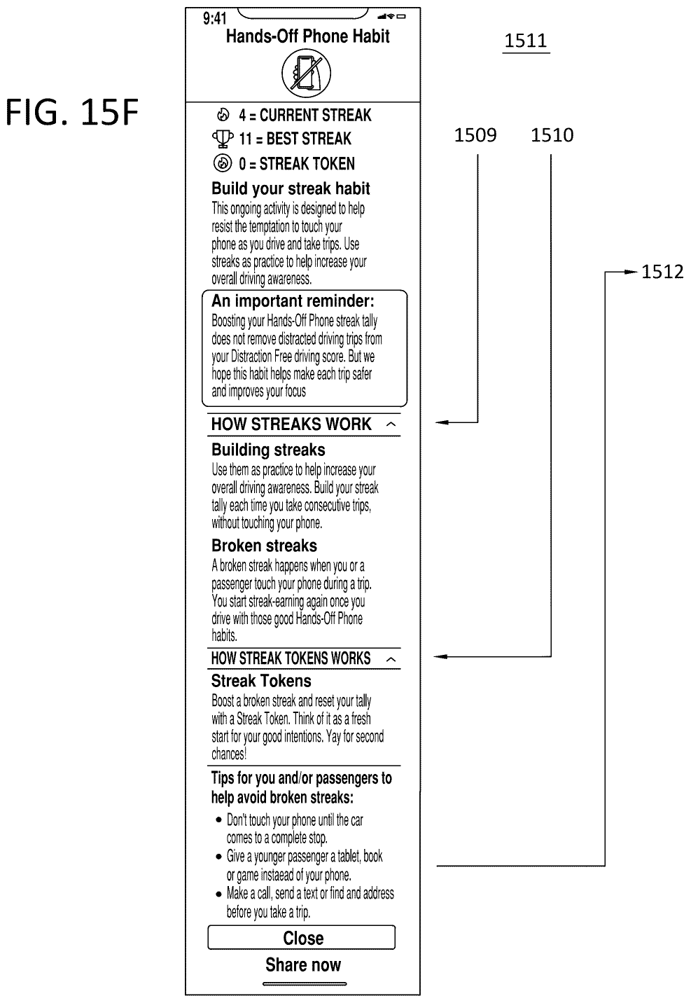

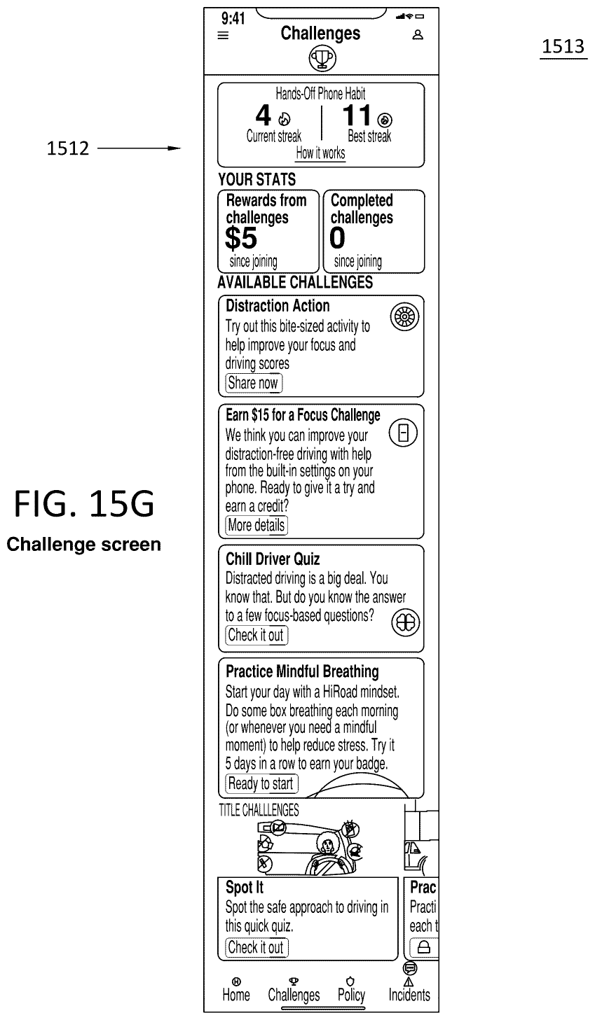

Turning to the next drawing, FIGS. 15A-15G illustrate a second portion of the flow chart and related displayed content displayed on a graphical user interface of a mobile electronic device, according to an embodiment. The displayed content is an embodiment and is not limited to the embodiments presented herein. The displayed content can be employed in many different embodiments or examples not specifically depicted or described herein. In a number of embodiments, the displayed content can include a graphical user interface for an app on the mobile electronic device, similar to the app and mobile electronic device described above with reference to FIGS. 12 and 13. In some embodiments, the graphical user interfaces and/or portions thereof of the displayed content can be arranged in the layout presented in FIGS. 15A-15G. In other embodiments, the graphical user interfaces and/or portions thereof of the displayed content can be arranged in any suitable layouts. In still other embodiments, one or more of the graphical user interfaces and/or the portions of the displayed content can be combined or omitted. In many embodiments, system 300 (FIG. 3), system 310 (FIG. 3), or method 400 (FIG. 4) can be suitable to generate, transmit, and/or display or cause to display the graphical user interfaces and/or any portions thereof.

As an example, FIGS. 15A-15G can show an introduction to boosting or mending a streak. More specifically, in some embodiments, starting from the home screen 1500 of the app (FIG. 15A), a user can click or tap 1501 a “Challenges” button at the bottom of the screen for the first time after having earned or been awarded a streak token to view the “Streak Tokens” screen (FIG. 15C) of the app to review information about streak tokens. In a different embodiment, starting from the locked home screen 1502 of the smartphone (FIG. 15B), the user can click or tap 1503 a “Coming soon: Streak Tokens” push notification to view, for the first time after having earned or been awarded a streak token, the “Streak Tokens” screen 1504 (FIG. 15C) of the app to review information about streak tokens.

From the “Streak Tokens” screen 1504 (FIG. 15C) of the app, the user can click or tap 1505 a “Close” button to view the “Challenges” screen 1506 (FIG. 15D) of the app. Now that the user has driven more times with the app since viewing the app in FIGS. 14A-14G, the “Challenges” screen 1506 of the app (FIG. 15D) shows that the current streak is four and the best streak is eleven. From the “Challenges” screen 1506 (FIG. 15D) of the app, the user can click or tap 1507 a “How it works” link to view a “Hands-Off Phone Habit” screen 1508 (FIG. 15E) of the app. The “Hands-Off Phone Habit” screen 1508 (FIG. 15E) of the app can show information about the current streak (which, again, is now four), the best streak (which, again, is now eleven), and the streak tokens (which is currently zero). The “Hands-Off Phone Habit” screen 1508 (FIG. 15E) of the app also can show information about building the user's streak habit, among other information.

When the user clicks or taps 1509 a “How streaks work” section on the “Hands-Off Phone Habit” screen 1508 (FIG. 15E) of the app, the user can view information about how streaks work on the “Hands-Off Phone Habit” screen 1511 (FIG. 15F) of the app, and when the user clicks or taps 1510 the “How streak tokens work” link on the “Hands-Off Phone Habit” screen 1508 (FIG. 15E) of the app, the user can view information about how streak tokens work on the “Hands-Off Phone Habit” screen 1511 (FIG. 15F) of the app. From the “Hands-Off Phone Habit” screen 1511 (FIG. 15F) of the app, the user can click or tap 1512 on the “Close” button to view the “Challenges” screen 1513 of the app (FIG. 15G).

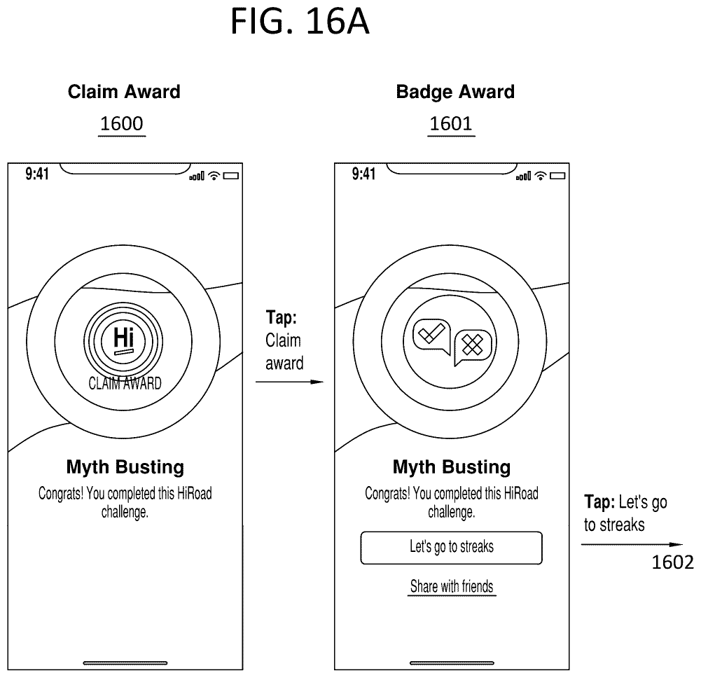

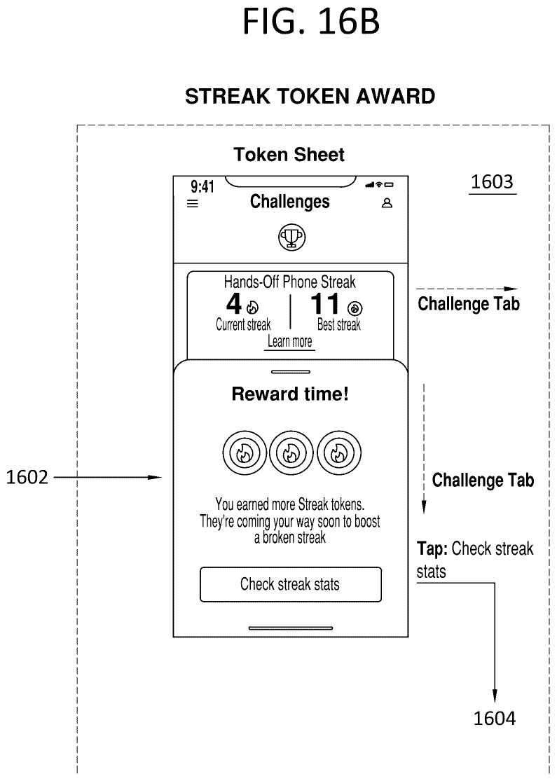

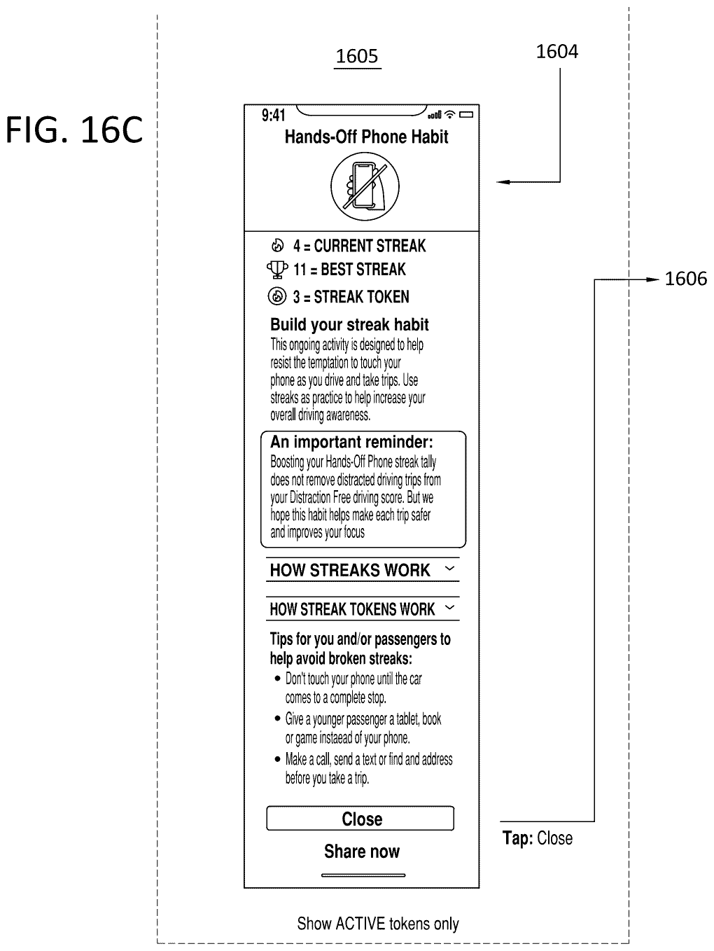

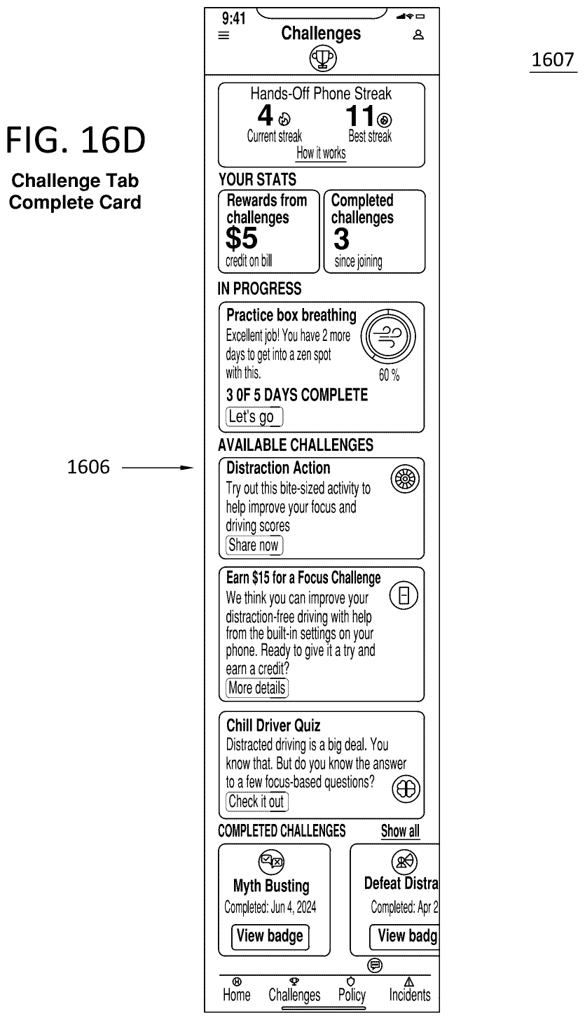

Continue with the drawings, FIGS. 16A-16D illustrate a third portion of the flow chart and related displayed content displayed on a graphical user interface of a mobile electronic device, according to an embodiment. The displayed content is an embodiment and is not limited to the embodiments presented herein. The displayed content can be employed in many different embodiments or examples not specifically depicted or described herein. In a number of embodiments, the displayed content can include a graphical user interface for an app on the mobile electronic device, similar to the app and mobile electronic device described above with reference to FIGS. 12 and 13. In some embodiments, the graphical user interfaces and/or portions thereof of the displayed content can be arranged in the layout presented in FIGS. 16A-16D. In other embodiments, the graphical user interfaces and/or portions thereof of the displayed content can be arranged in any suitable layouts. In still other embodiments, one or more of the graphical user interfaces and/or the portions of the displayed content can be combined or omitted. In many embodiments, system 300 (FIG. 3), system 310 (FIG. 3), or method 400 (FIG. 4) can be suitable to generate, transmit, and/or display or cause to display the graphical user interfaces and/or any portions thereof.

As an example, FIGS. 16A-16D can show the user earning a streak token after completing a challenge. More specifically, in some embodiments, after clicking or tapping on a myth busting challenge on the home screen of the app and after completing the challenge, the user can view a Claim Award screen 1600 (FIG. 16A) of the app. After clicking or tapping a “CLAIM AWARD” link on the Claim Award screen 1600 (FIG. 16A) of the app, the user can view a Badge Award screen 1601 (FIG. 16A) of the app. After clicking or tapping 1602 a “Let's go to streaks” button on the Badge Award screen 1601 (FIG. 16A) of the app, the user can view a Token Sheet screen 1603 (FIG. 16B) of the app. On the Token Sheet screen 1603 (FIG. 16B) of the app, the user can click or tap 1604 a “Check streak stats” button to view the “Hands-Off Phone Habit” screen 1605 (FIG. 16C) of the app. The “Hands-Off Phone Habit” screen 1604 (FIG. 16C) of the app can show information about the current streak (which remains at four), the best streak (which remains at eleven), and the streak tokens (which is now at three). In this example, the user can earn three streak tokens each time that the user completes a challenge. In other examples, the user can earn only one streak token for completing a challenge, or the user can earn a different number of streak tokens depending on the challenge completed.

From the “Hands-Off Phone Habit” screen 1605 (FIG. 16C) of the app, the user can click or tap 1606 a “Close” button to view the “Challenges” screen 1607 (FIG. 16D) of the app. Now, the “Challenges” screen 1607 (FIG. 16D) of the app shows the “Completed challenges”, which is now three, assuming that the completed myth busting challenge is the third challenge completed by the user. The “Challenges” screen 1607 (FIG. 16D) of the app also shows that another challenge “box breathing” is in progress, and that the user previously completed a “Defeat Distractions” challenge and the “Myth Busting” challenge.

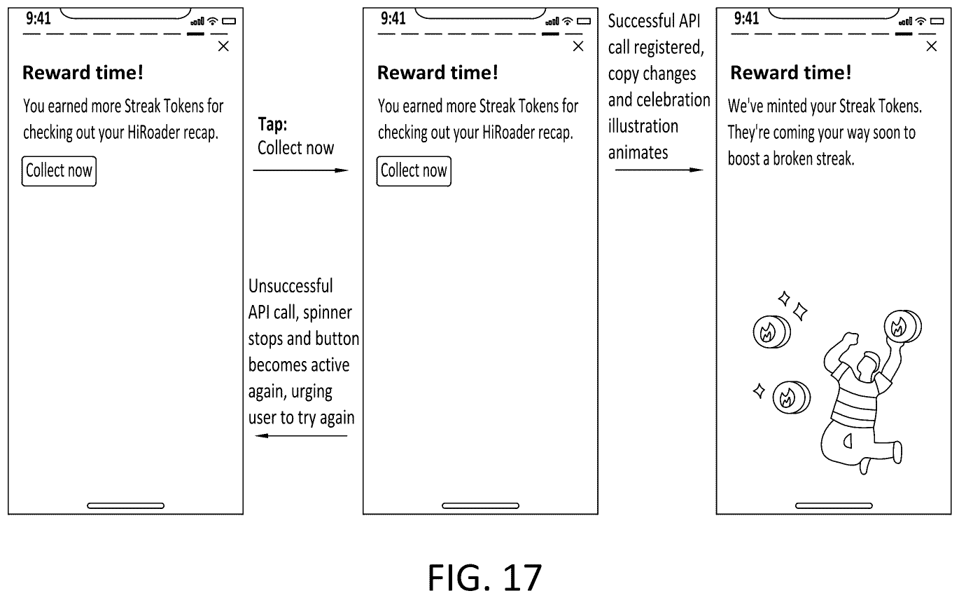

Turning to the next drawing, FIG. 17 illustrates a fourth portion of the flow chart and related displayed content displayed on a graphical user interface of a mobile electronic device, according to an embodiment. The displayed content is an embodiment and is not limited to the embodiments presented herein. The displayed content can be employed in many different embodiments or examples not specifically depicted or described herein. In a number of embodiments, the displayed content can include a graphical user interface for an app on the mobile electronic device, similar to the app and mobile electronic device described above with reference to FIGS. 12 and 13. In some embodiments, the graphical user interfaces and/or portions thereof of the displayed content can be arranged in the layout presented in FIG. 17. In other embodiments, the graphical user interfaces and/or portions thereof of the displayed content can be arranged in any suitable layouts. In still other embodiments, one or more of the graphical user interfaces and/or the portions of the displayed content can be combined or omitted. In many embodiments, system 300 (FIG. 3), system 310 (FIG. 3), or method 400 (FIG. 4) can be suitable to generate, transmit, and/or display or cause to display the graphical user interfaces and/or any portions thereof.

As an example, FIG. 17 can show screens of the app awarding streak tokens to the user after the user reviews a monthly summary or recap of the user's driving scores and habits. More specifically, in some embodiments, after clicking or tapping a “Driving Scores” statistics on the home screen (FIG. 14A) of the app, the user can review her monthly summary or recap of driving scores and habits. After that review, the user can view a first “Reward time!” screen of the app regarding an announcement of the award of streak tokens. After clicking or tapping the “Collect now” button, the user can view a second “Reward time!” screen of the app while the app executes an API (application programming interface) call and awaits confirmation of the award. Upon receipt of the confirmation, the user can view a third “Reward time!” screen of the app regarding the minting of one or more streak tokens for the user. So now, the user can have 3 more streak tokens, for a total of six streak tokens.

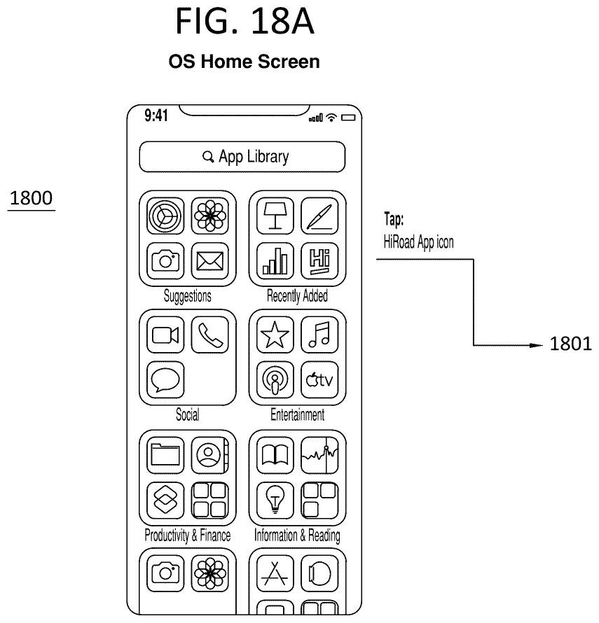

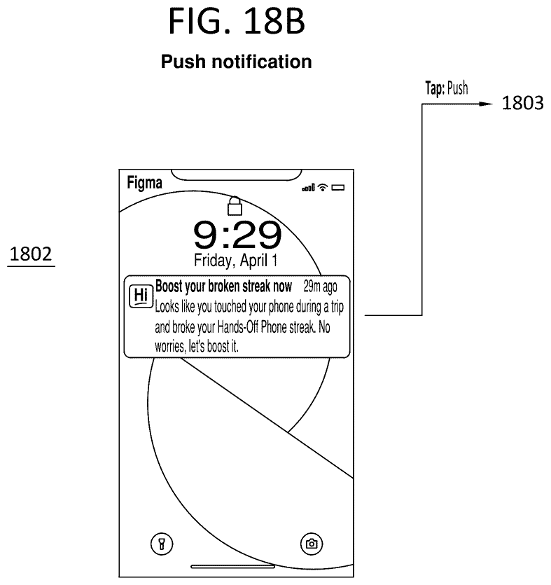

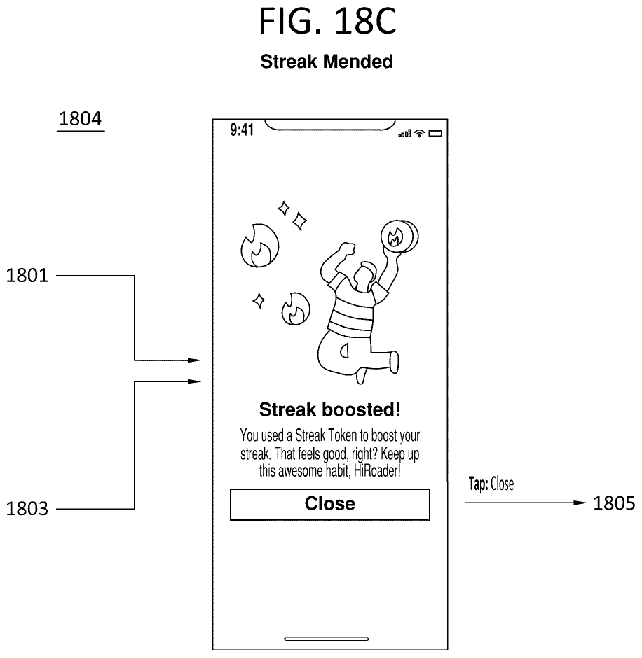

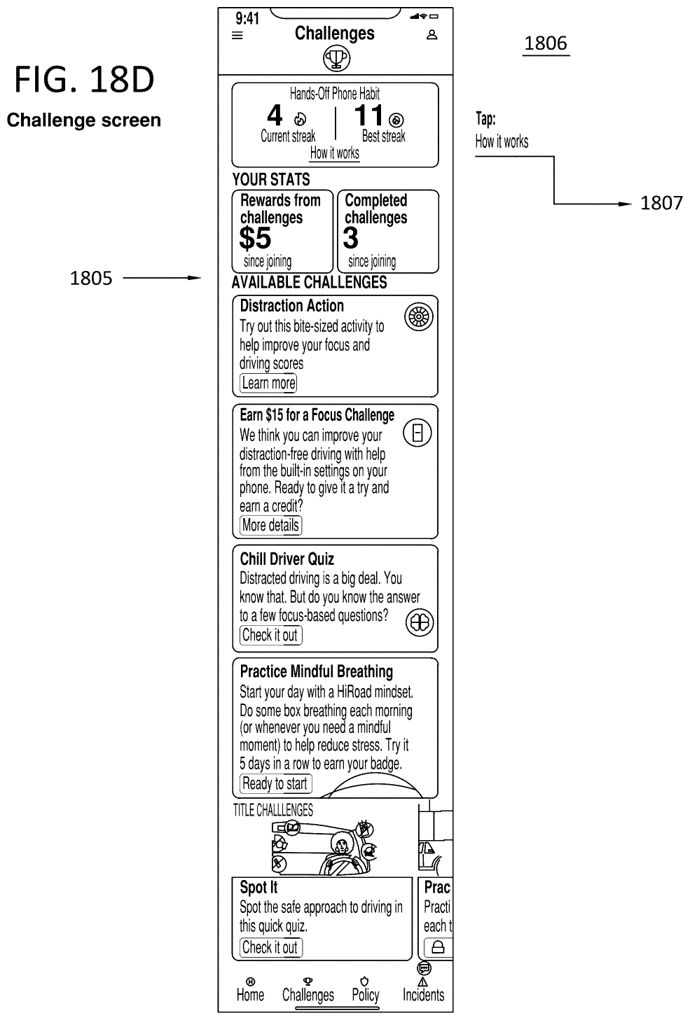

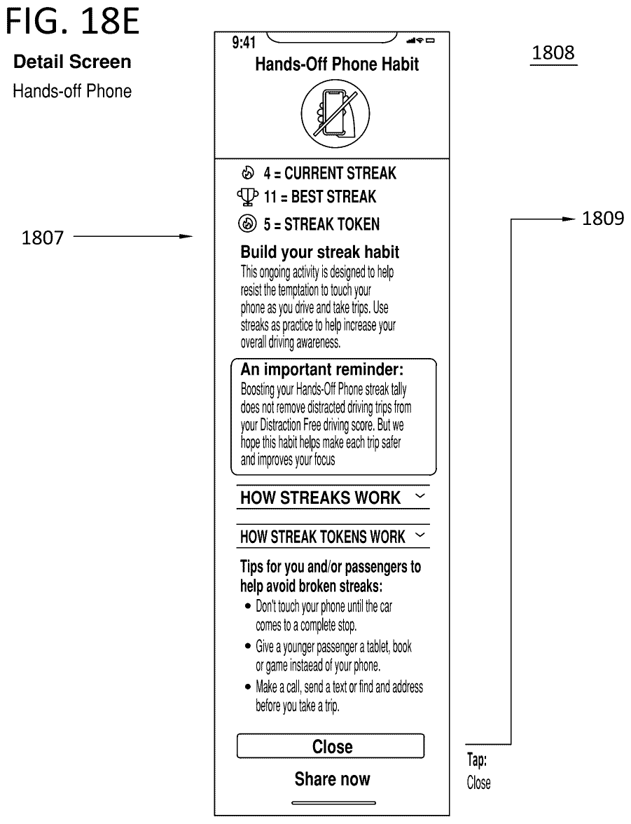

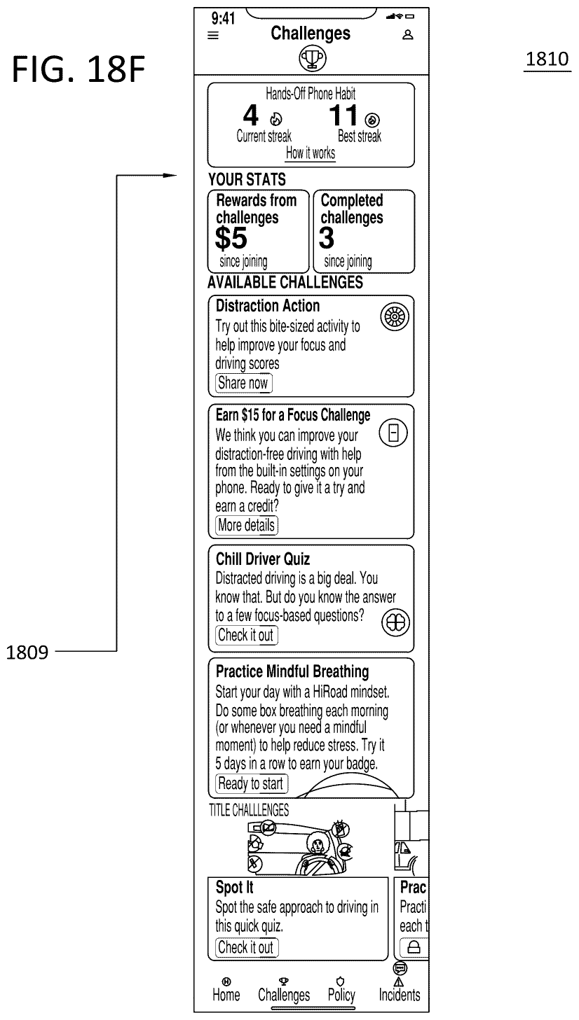

Continue with the drawings, FIGS. 18A-18F illustrate a fifth portion of the flow chart and related displayed content displayed on a graphical user interface of a mobile electronic device, according to an embodiment. The displayed content is an embodiment and is not limited to the embodiments presented herein. The displayed content can be employed in many different embodiments or examples not specifically depicted or described herein. In a number of embodiments, the displayed content can include a graphical user interface for an app on the mobile electronic device, similar to the app and mobile electronic device described above with reference to FIGS. 12 and 13. In some embodiments, the graphical user interfaces and/or portions thereof of the displayed content can be arranged in the layout presented in FIGS. 18A-18F. In other embodiments, the graphical user interfaces and/or portions thereof of the displayed content can be arranged in any suitable layouts. In still other embodiments, one or more of the graphical user interfaces and/or the portions of the displayed content can be combined or omitted. In many embodiments, system 300 (FIG. 3), system 310 (FIG. 3), or method 400 (FIG. 4) can be suitable to generate, transmit, and/or display or cause to display the graphical user interfaces and/or any portions thereof.

As an example, FIG. 18A can show the boosting or mending of a driving streak after the user breaks the driving streak. More specifically, in some embodiments, starting from the home screen 1800 of the smartphone, the user can click or tap 1801 the app to view a “Streak boosted!” screen 1804 (FIG. 18C) of the app notifying the user about the automatic redemption of a streak token to boost or mend a break in the user's driving streak. In a different embodiment, starting from the locked home screen 1802 of the smartphone (FIG. 18B), the user can click or tap 1803 the “Boost your broken streak now!” push notification to view the “Streak boosted!” screen 1804 (FIG. 18C) of the app notifying the user about the automatic redemption of the streak token to boost or mend the break in the user's driving streak.

After clicking or tapping 1805 a “Close” button on the “Streak boosted!” screen 1804 (FIG. 18A) of the app, the user can view the “Challenges” screen 1806 (FIG. 18D) of the app. On the “Challenges” screen 1806 (FIG. 18D) of the app, the current streak is restored to four, and the best streak remains at eleven. (Before the streak token was redeemed, the current streak was reset to zero.) In this embodiment, the redemption of the streak token does not convert the driving trip causing the break in the driving streak from a distracted trip to a non-distracted trip, but rather excuses the distracted trip or bridges a gap in the driving streak such that the current streak is restored to its prior number. Accordingly, after redeeming the streak token, the current streak is changed from zero to four, instead of from zero to five.

After clicking or tapping 1807 on the “How it works” link on the “Challenges” screen 1806 (FIG. 18D) of the app, the user can view the “Hands-Off Phone Habit” screen 1808 (FIG. 18E) of the app. The “Hands-Off Phone Habit” screen 1808 (FIG. 18E) of the app shows the current streak at four and the best streak at eleven, but the streak tokens are now at five (instead of six, as described with reference to FIG. 17) because one of the streak tokens was redeemed to boost or mend the driving streak. Next, after clicking or tapping 1809 the “Close” button on the “Hands-Off Phone Habit” screen 1808 (FIG. 18E) of the app, then user can view the “Challenges” screen 1810 (FIG. 18F) of the app.

Turning to the next drawing, FIG. 19 illustrates examples of streak token application logic, according to an embodiment. In one example, a user earns three streak tokens. The three tokens can be redeemed to boost or mend the user's driving streak by being applied to the 3 most recent breaks in the user's driving streak. If the user did not break the driving streak or if the user broke the streak only twice or once, then the number of remaining streak tokens will be reflected in the user's “Hands-Off Phone Habit” screen.

In another example, referring to timeline 1901 in FIG. 19, a user drives three trips in a row without using the user's mobile electronic device for any purpose other than pre-approved purposes during the three trips. As a result, the user's driving streak is three.

Then, as shown in timeline 1902 in FIG. 19, the user drives eight additional trips, where the first, third, fifth, and sixth additional trips create breaks in the user's driving streak. Accordingly, after the first additional trip (which is the fourth trip in total), the user's driving streak is reset to zero, and after the second additional trip (which is the fifth trip in total), the user's driving streak improves to one. Next, after the third additional trip (which is the sixth trip in total), the user's driving streak is reset to zero again, and after the fourth additional trip (which is the seventh trip in total), the user's driving streak is one, again. Then, after the fifth additional trip (which is the eighth trip in total), the user's driving streak returns to zero, and after the sixth additional trip (which is the ninth trip in total), the user's driving streak remains at zero. Subsequently, after the seventh additional trip (which is the tenth trip in total), the user's driving streak is one, and after the eighth additional trip (which is the eleventh trip in total), the user's driving streak increases to two.

After driving the eight additional trips (or a total of eleven trips), the user earns two streak tokens, and as shown in timeline 1903, the two streak tokens are redeemed and used to boost or mend the user's driving streak by being applied to the two most recent breaks in the driving streak. Specifically, a first streak token of the two streak tokens is applied to the break caused by the fifth and sixth additional trips, and then a second streak token of the two streak tokens is applied to the break caused by the third additional trip. The user does not have a third streak token, so the break caused by the first additional trip cannot be boosted or mended. Accordingly, a gap caused by the first additional trip remains in the driving streak, such that the user's driving streak is boosted or mended to be four. As noted in this embodiment, a single streak token can be applied to bridge a gap caused by more than one trip. As also noted in this same embodiment, the trips to which streak tokens are applied do not increase the driving streak count.

In some embodiments, the systems and methods described in this section and elsewhere can solve at least one or more of the following technical problems related to encouraging and maintaining safe driving behavior: (1) Accurate detection of distraction-free driving: The systems and methods can process complex telematics data to reliably identify periods of distraction-free driving, which can address the challenge of accurately measuring driver behavior. (2) Continuous engagement maintenance: The application of streak tokens can solve the problem of user disengagement when driving streaks are broken, which can maintain the effectiveness of the behavior modification system. (3) Real-time behavior tracking and reinforcement: The systems and methods can provide immediate feedback and rewards, which can address the challenge of timely reinforcement of positive behaviors in a mobile environment. (4) Data misclassification correction: The ability to detect and correct misclassified trips can solve the problem of inaccurate data potentially disrupting the streak systems and methods, which can improve the reliability and trustworthiness of the systems and methods. (5) Personalized incentive delivery: By allowing customization of streak token application and providing various ways to earn streak tokens, the systems and methods can address the challenge of delivering effective, personalized incentives to diverse users. (6) Efficient server-client data processing: The distribution of processing tasks between server and mobile device can improve resource usage and system responsiveness. (7) Long-term engagement sustainability: The implementation of features like decay mechanisms and variable reward rates can address the technical challenge of maintaining user engagement over extended periods of time. (8) Privacy-conscious behavior tracking: The systems and methods can encourage safe driving without requiring constant, real-time monitoring, which can address privacy concerns associated with tracking driver behavior. (9) Integration of social elements in a personal activity: The gifting feature can solve the problem of incorporating social motivation into an otherwise solitary activity (driving). (10) Adaptive reward system implementation: The system's ability to adjust token awarding rates based on streak length and/or tenure can solve the problem of diminishing returns in fixed reward systems. (11) Complex behavior pattern recognition: By tracking streaks and milestones, the systems and methods can address the challenge of recognizing and rewarding sustained behavior changes over time. (12) Mobile resource optimization: The systems and methods can encourage engagement with the app while minimizing battery and data usage during driving, addressing the challenge of providing an engaging mobile experience without compromising device performance or safety. These technical solutions can collectively address technical challenges in behavior modification, data processing, user engagement, and mobile application design within the context of encouraging safe driving practices.

Additionally, in some embodiments, the systems and methods described in this section and elsewhere can provide one or more of the following additional technical improvements: (1) Enhanced telematics data processing: The systems and methods can process telematics data to determine distraction-free driving streaks, which can provide a more sophisticated analysis of driving behavior beyond basic metrics. (2) Automated streak maintenance: The systems and methods can automatically apply streak tokens to continue a user's driving streak, which can reduce manual intervention and reducing administrative tasks for the user to improve user engagement with the app. (3) Dynamic token awarding system: The systems and methods can award streak tokens based on various criteria (e.g., completed trips, viewing recaps, quizzes, etc.), which can create a more comprehensive and flexible reward system. (4) Intelligent streak break detection: The systems and methods can detect breaks in driving streaks and differentiate between actual breaks and misclassified trips, which can improve accuracy. (5) Customizable token application: Users can opt out or customize conditions for automatic token application, which can allow for a more personalized experience. (6) Integration of gamification elements: The systems and methods can incorporate challenges, milestones, and/or a marketplace, enhancing user engagement and motivation. (7) Adaptive token awarding rates: The systems and methods can adjust token awarding rates based on driving streak length and/or tenure, which can provide a more nuanced reward system and motivating and rewarding long-term customers. (8) Cross-user interaction features: The ability to gift tokens to other users can add a social component to the system. (9) Server-client architecture optimization: The systems and methods can efficiently distribute processing between a server and mobile device, which can improve performance and reducing mobile device resource usage. (10) Decay mechanism for tokens: The systems and methods can encourage regular engagement and can prevent streak token hoarding, which can maintain the system's effectiveness over time. These technical improvements can create more sophisticated, engaging, and effective systems and methods for encouraging and maintaining safe driving behaviors through technological means.

### Exemplary Machine Learning Models

In many embodiments, the systems and/or methods can use one or more ML/AI models to perform one or more of the above-mentioned procedures, processes, activities, actions, operations, and/or methods. Examples of the algorithms used for the various ML/AI models can include BERT, LLM, Lambda, Palm, XLNet, GPT-3 (generative pre-training transformer), GPT-4, KNN (k-nearest neighbor), decision trees, linear regression, logistic regression, K-Means, neural networks, fuzzy logic, GANs (generative adversarial networks), CTGAN (cloud transformer generative adversarial networks), CNNs (convolutional neural networks), VAEs (variational autoencoder), and so forth. In various embodiments, each of the ML/AI models used can be trained and/or retrained dynamically and/or regularly.

In many embodiments, the systems and/or methods can be configured to train or re-train the one or more ML/AI models. The training of each of the ML/AI models can be supervised, semi-supervised, and/or unsupervised-which in some embodiments can be followed by, or used in conjunction with, other techniques, such as re-enforcement machine learning techniques, or other techniques utilized by ChatGPT-based voice bots or virtual assistants. The training data of training datasets for pre-training or re-training each of the ML/AI models can be collected from various data sources, including historical input and/or output data by the ML/AI model. The collection and update of the training data in the training datasets can be performed once, periodically (e.g., every day, every week, etc.), or constantly. For example, in certain embodiments, the input and/or output data of an ML/AI model can be curated by a user (e.g., an ML engineer, a data scientist, etc.) or automatically collected every time the ML/AI model generates new output data to update the training datasets for re-training the ML/AI model. In many embodiments, the trained and/or re-trained ML/AI model as well as the training datasets can be stored in, updated, and accessed from a database (e.g., database(s) 330 (FIG. 3)). In the same or different embodiments, when more than one training dataset is used for the pre-training and/or re-training, the data of the more than one training dataset can be formatted or reformatted so that the hierarchy, schema, and/or other aspects of the data of the more than one training dataset (especially when datasets are from different sources) follow a common hierarchy, structure, schema, etc., and so that the data of the more than one training dataset can be more easily used to pre-train or re-train the one or more machine learning models. In many embodiments, the common hierarchy, structure, schema, etc. can be predetermined.

In some embodiments, the users, systems, and/or methods further can determine whether to add the newly created historical input and/or output data to the training dataset for retraining the ML/AI models based upon user feedback, predetermined criteria, and/or confidence scores for the historical output data. The user feedback can be associated with the output data of the ML/AI models or the output of the systems and/or methods using the ML/AI models.

In certain embodiments where machine learning techniques are not explicitly described in the processes, procedures, activities, operations, actions, and/or methods, such processes, procedures, activities, operations, actions, and/or methods can be read to include machine learning techniques suitable to perform the intended activities (e.g., determining, processing, analyzing, predicting, etc.). In several embodiments, the one or more ML/AI models can be configured to start or stop automatically upon occurrence of predefined events and/or conditions. In certain embodiments, the systems and/or methods can use a pre-trained ML/AI model, without any re-training.

### ADDITIONAL CONSIDERATIONS

Although providing a graphical user interface for testing cognitive factors for a user based on the user's gaming performance has been described with reference to specific embodiments, it will be understood by those skilled in the art that various changes can be made without departing from the spirit or scope of the disclosure. Accordingly, the disclosure of embodiments is intended to be illustrative of the scope of the disclosure and is not intended to be limiting.

It is intended that the scope of the disclosure shall be limited only to the extent required by the appended claims. For example, to one of ordinary skill in the art, it will be readily apparent that any element of FIGS. 1-19 can be modified, and that the foregoing discussion of certain of these embodiments does not necessarily represent a complete description of all possible embodiments. Additionally, one or more of the procedures, processes, operations, actions, and/or activities of the method in FIGS. 4 and/or 12 can include different procedures, processes, actions, and/or activities and be performed by many different modules, in many different orders. One or more elements of the displayed content in any of FIGS. 5-11 and/or 13-18 can include different graphical user interfaces, gaming interfaces, activation controls, and/or visual prompts, etc., and include any suitable arrangements and/or layouts. As another example, the modules, models, elements, and/or systems within system 300 or system 310 in FIG. 3 can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that can cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

As will be appreciated based upon the foregoing specification, the above-described embodiments of the disclosure can be implemented using computer programming or engineering techniques including computer software, firmware, hardware or any combination or subset thereof. Any such resulting program, having computer-readable code means, can be embodied, or provided within one or more computer-readable media, thereby making a computer program product, e.g., an article of manufacture, according to the discussed embodiments of the disclosure. The computer-readable media can be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code can be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor can include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM (erasable programmable read-only memory) memory, EEPROM (electrically erasable programmable read-only memory) memory, and non-volatile RAM (NVRAM) memory. The above memory types are example only and are thus not limiting as to the types of memory usable for storage of a computer program.

In one embodiment, a computer program is provided, and the program is embodied on a computer readable medium. In an exemplary embodiment, the system can be executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various environments without compromising any major functionality. In some embodiments, the system includes multiple components distributed among a plurality of computing devices. One or more components can be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and preceded by the word “a” or “an” should be understood as not excluding plural elements, actions, operations, or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112 (f) unless traditional means-plus-function language is expressly recited, such as “means for” or “step for” language being expressly recited in the claim(s).

For simplicity and clarity of illustration, the drawing figures illustrate the general manner of construction, and descriptions and details of well-known features and techniques can be omitted to avoid unnecessarily obscuring the present disclosure. Additionally, elements in the drawing figures are not necessarily drawn to scale. For example, the dimensions of some of the elements in the figures can be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but can include other elements not expressly listed or inherent to such process, method, system, article, device, or apparatus.

The terms “couple,” “coupled,” “couples,” “coupling,” and the like should be broadly understood and refer to connecting two or more elements mechanically and/or otherwise. Two or more electrical elements can be electrically coupled together, but not be mechanically or otherwise coupled together. Coupling can be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, “approximately” may, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

This written description uses examples to disclose the disclosure, including the best mode, and to enable any person skilled in the art to practice the disclosure, including making and using any devices or computer systems and performing any incorporated computer-based or computer-implemented methods. The patentable scope of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method being implemented via execution of computing instructions configured to run on one or more processors and stored on one or more non-transitory computer-readable media, the method comprising:
receiving telematics data associated with a trip by a vehicle operated by a user;
determining, based on the telematics data, that the user has achieved a driving streak of two or more trips without use of a mobile electronic device of the user for any purpose other than pre-approved purposes during the two or more trips;
awarding one or more streak tokens to the user based on the user completing a predetermined action;
detecting a break in the driving streak of the user;
redeeming at least one streak token of the one or more streak tokens of the user; and
mending, using the at least one streak token, the driving streak of the user.

2. The method of claim 1, wherein:
awarding the one or more streak tokens comprises:
making a determination that the user has completed a milestone; and
awarding a first streak token in response to the determination.

3. The method of claim 1, wherein:
awarding the one or more streak tokens comprises:
determining a driving score based on the telematics data; and
awarding a first streak token based on the driving score.

4. The method of claim 1, wherein:
detecting the break comprises:
determining that a single trip occurred during which the mobile electronic device was used for a purpose other than the pre-approved purposes, wherein the single trip was for the vehicle operated by the user; and
mending, using the at least one streak token, the driving streak of the user comprises:
applying the at least one streak token of the one or more streak tokens to bridge a gap in the driving streak of the user caused by the single trip.

5. The method of claim 1, further comprising:
transmitting a token redemption notification via a user interface of the mobile electronic device of the user after the at least one streak token is redeemed and used to mend the driving streak of the user.

6. The method of claim 1, further comprising:
transmitting, via a user interface of the mobile electronic device of the user, a current count of streak tokens of the user.

7. The method of claim 1, further comprising:
receiving at least one of the one or more streak tokens from the user to be provided to one or more other users.

8. A system comprising:
one or more processors; and
one or more non-transitory computer-readable media storing computing instructions that, when run on the one or more processors, cause the one or more processors to perform operations comprising:
receiving telematics data associated with a trip by a vehicle operated by a user;
determining, based on the telematics data, that the user has achieved a driving streak of two or more trips without use of a mobile electronic device of the user for any purpose other than pre-approved purposes during the two or more trips;
awarding one or more streak tokens to the user based on the user completing a predetermined action;
detecting a break in the driving streak of the user;
redeeming at least one streak token of the one or more streak tokens of the user; and
mending, using the at least one streak token, the driving streak of the user.

9. The system of claim 8, wherein:
awarding the one or more streak tokens comprises:
making a determination that the user has completed a milestone; and
awarding a first streak token in response to the determination.

10. The system of claim 8, wherein:
awarding the one or more streak tokens comprises:
determining a driving score based on the telematics data; and
awarding a first streak token based on the driving score.

11. The system of claim 8, wherein:
determining that a single trip occurred during which the mobile electronic device was used for a purpose other than the pre-approved purposes, wherein the single trip was for the vehicle operated by the user; and
applying the at least one streak token of the one or more streak tokens to bridge a gap in the driving streak of the user caused by the single trip.

12. The system of claim 8, wherein the operations further comprise:
transmitting a token redemption notification via a user interface of the mobile electronic device of the user after the at least one streak token is redeemed and used to mend the driving streak of the user.

13. The system of claim 8, wherein the operations further comprise:
transmitting, via a user interface of the mobile electronic device of the user, a current count of streak tokens of the user.

14. The system of claim 8, wherein the operations further comprise:
receiving at least one of the one or more streak tokens from the user to be provided to one or more other users.

15. A non-transitory computer readable storage medium storing computing instructions, the computing instructions, when run on one or more processors, causing the one or more processors to perform operations comprising:
receiving telematics data associated with a trip by a vehicle operated by a user;
determining, based on the telematics data, that the user has achieved a driving streak of two or more trips without use of a mobile electronic device of the user for any purpose other than pre-approved purposes during the two or more trips;
awarding one or more streak tokens to the user based on the user completing a predetermined action;
detecting a break in the driving streak of the user;
redeeming at least one streak token of the one or more streak tokens of the user; and
mending, using the at least one streak token, the driving streak of the user.

16. The non-transitory computer readable storage medium of claim 15, wherein:
awarding the one or more streak tokens comprises:
making a determination that the user has completed a milestone; and
awarding a first streak token in response to the determination.

17. The non-transitory computer readable storage medium of claim 15, wherein:
awarding the one or more streak tokens comprises:
determining a driving score based on the telematics data; and
awarding a first streak token based on the driving score.

18. The non-transitory computer readable storage medium of claim 15, wherein:
detecting the break comprises:
determining that a single trip occurred during which the mobile electronic device was used for a purpose other than the pre-approved purposes, wherein the single trip was for the vehicle operated by the user; and
applying the at least one streak token of the one or more streak tokens to bridge a gap in the driving streak of the user caused by the single trip.

19. The non-transitory computer readable storage medium of claim 15, wherein the operations further comprise at least one of:
transmitting a token redemption notification via a user interface of the mobile electronic device of the user after the at least one streak token is redeemed and used to mend the driving streak of the user; or
transmitting, via the user interface of the mobile electronic device of the user, a current count of streak tokens of the user.

20. The non-transitory computer readable storage medium of claim 15, wherein the operations further comprise:
receiving at least one of the one or more streak tokens from the user to be provided to one or more other users.
